(19) United States
(12) Patent Application Publication
(10) Pub. No.: US 2026/0181521 A1
(43) Pub. Date: Jun. 25, 2026

(54) METHODS, DEVICES AND COMPUTER-READABLE MEDIUM FOR COMMUNICATION

(71) Applicant: Nokia Technologies Oy, Espoo (FI)

(72) Inventors: Jing PING, Chengdu (CN); Ranganathan MAVUREDDI DHANASEKARAN, Munich (DE); Suresh P NAIR, Estero, FL (US)

(21) Appl. No.: 19/127,649

(22) PCT Filed: Nov. 7, 2022
(86) PCT No.: PCT/CN2022/130321

§ 371 Date: May 6, 2025

(51) Int. Cl. H04W 40/22; H04W 8/22; H04W 12/0433; H04W 48/18; H04W 92/18

(52) U.S. Cl. CPC H04W 40/22; H04W 8/22; H04W 12/0433; H04W 48/18; H04W 92/18

(57) ABSTRACT

Example embodiments of the present disclosure relate to methods, devices, apparatuses and a computer-readable medium for communication to enhance security for path switching between relay terminal devices. In an example method, based on determining that path switching from a source relay terminal device having a first relay service code (RSC) associated with a first set of security policies is triggered, a remote terminal device determines a second RSC. The remote terminal device obtains a second set of security policies associated with the second RSC. Then, the remote terminal device selects a candidate relay terminal device having the second RSC as a target relay terminal device for the path switching in the event that the second set of security policies match the first set of security policies. In this way, the security policies to be used after path switching could be ensured to match the security policies before path switching.

### FIELD

Example embodiments of the present disclosure generally relate to the field of communication, and in particular, to methods, devices, apparatuses and a computer-readable medium for communication to enhance security for path switching between relay terminal devices.

### BACKGROUND

In conventional 3GPP standards, SA2 working group has defined mechanism for proximity services (ProSe) remote terminal device to reselect a UE-to-Network (U2N) relay terminal device from multiple candidate relay terminal devices for path switching. SA3 working group has defined security for a discovery procedure to allow a remote terminal device to select a U2N relay terminal device based on relay service code (RSC) and other parameters. However, security for path switching between relay terminal devices may still need to be studied and enhanced.

### SUMMARY

In general, example embodiments of the present disclosure provide methods, devices, apparatuses and a computer-readable medium for communication, for example, to enhance security for path switching between relay terminal devices, especially to enhance the consistency of security policies during path switching across different RSCs.

In a first aspect, there is provided a remote terminal device. The remote terminal device comprises at least one processor and at least one memory storing instructions that, when executed by the at least one processor, cause the remote terminal device to: based on determining that path switching from a source relay terminal device having a first relay service code (RSC) associated with a first set of security policies is triggered, determine a second RSC; obtain a second set of security policies associated with the second RSC; and select a candidate relay terminal device having the second RSC as a target relay terminal device for the path switching in the event that the second set of security policies match the first set of security policies.

In a second aspect, there is provided a control function device. The control function device comprises at least one processor; and at least one memory storing instructions that, when executed by the at least one processor, cause the control function device to: based on receiving, from a remote terminal device associated with the control function device, a discovery key request comprising a second relay service code (RSC), obtain a second set of security policies associated with the second RSC, the set of second security policies comprising at least one second user plane (UP) security policy of a second packet data unit (PDU) session; and send, to the remote terminal device, a discovery key response comprising the second set of security policies associated with the second RSC.

In a third aspect, there is provided a policy control function (PCF) device. The PCF device comprises at least one processor; and at least one memory storing instructions that, when executed by the at least one processor, cause the PCF device to: send, to a remote terminal device, a set of security policies associated with a plurality of relay service codes (RSCs), the plurality of RSCs comprise a first RSC associated with a source relay terminal device and a second RSC associated with a candidate relay terminal device, the set of security policies comprising at least one user plane (UP) security policy of a packet data unit (PDU) session.

In a fourth aspect, there is provided a policy control function (PCF) device. The PCF device comprises at least one processor; and at least one memory storing instructions that, when executed by the at least one processor, cause the PCF device to: obtain, for a relay terminal device from a unified data management (UDM) device, a first set of security policies associated with the relay terminal device; compare the first set of security policies with a second set of security policies associated with a relay service code (RSC); and based on determining that the first set of security policies match the second set of security policies, authorize the RSC to the relay terminal device.

In a fifth aspect, there is provided a method implemented in a remote terminal device according to the first aspect. The method comprises: based on determining that path switching from a source relay terminal device having a first relay service code (RSC) associated with a first set of security policies is triggered, determining, at a remote terminal device, a second RSC; obtaining, at the remote terminal device, a second set of security policies associated with the second RSC; and selecting, at the remote terminal device, a candidate relay terminal device having the second RSC as a target relay terminal device for the path switching in the event that the second set of security policies match the first set of security policies.

In a sixth aspect, there is provided a method implemented at a control function device according to the second aspect. The method comprises: based on receiving, from a remote terminal device associated with the control function device, a discovery key request comprising a second relay service code (RSC), obtaining, at a control function device, a second set of security policies associated with the second RSC, the set of second security policies comprising at least one second user plane (UP) security policy of a second packet data unit (PDU) session; and sending, from the control function device to the remote terminal device, a discovery key response comprising the second set of security policies associated with the second RSC.

In a seventh aspect, there is provided a method implemented at a policy control function (PCF) device according to the third aspect. The method comprises: sending, from a policy control function (PCF) device to a remote terminal device, a set of security policies associated with a plurality of relay service codes (RSCs), the plurality of RSCs comprise a first RSC associated with a source relay terminal device and a second RSC associated with a candidate relay terminal device, the set of security policies comprising at least one user plane (UP) security policy of a packet data unit (PDU) session.

In an eighth aspect, there is provided a method implemented at a policy control function (PCF) device according to the fourth aspect. The method comprises: obtaining, at a policy control function (PCF) device, for a relay terminal device from a unified data management (UDM) device, a first set of security policies associated with the relay terminal device; comparing, at the PCF device, the first set of security policies with a second set of security policies associated with a relay service code (RSC); and based on determining that the first set of security policies match the second set of security policies, authorizing, at the PCF device, the RSC to the relay terminal device.

In a ninth aspect, there is provided an apparatus implemented in a remote terminal device according to the first aspect. The apparatus comprises: means for based on determining that path switching from a source relay terminal device having a first relay service code (RSC) associated with a first set of security policies is triggered, determining, at a remote terminal device, a second RSC; means for obtaining, at the remote terminal device, a second set of security policies associated with the second RSC; and means for selecting, at the remote terminal device, a candidate relay terminal device having the second RSC as a target relay terminal device for the path switching in the event that the second set of security policies match the first set of security policies.

In a tenth aspect, there is provided an apparatus implemented in a control function device according to the second aspect. The apparatus comprises: means for based on receiving, from a remote terminal device associated with the control function device, a discovery key request comprising a second relay service code (RSC), obtaining, at a control function device, a second set of security policies associated with the second RSC, the set of second security policies comprising at least one second user plane (UP) security policy of a second packet data unit (PDU) session; and means for sending, from the control function device to the remote terminal device, a discovery key response comprising the second set of security policies associated with the second RSC.

In an eleventh aspect, there is provided an apparatus implemented in a policy control function (PCF) device according to the third aspect. The apparatus comprises: means for sending, from a policy control function (PCF) device to a remote terminal device, a set of security policies associated with a plurality of relay service codes (RSCs), the plurality of RSCs comprise a first RSC associated with a source relay terminal device and a second RSC associated with a candidate relay terminal device, the set of security policies comprising at least one user plane (UP) security policy of a packet data unit (PDU) session.

In a twelfth aspect, there is provided an apparatus implemented in a policy control function (PCF) device according to the fourth aspect. The apparatus comprises: means for obtaining, at a policy control function (PCF) device, for a relay terminal device from a unified data management (UDM) device, a first set of security policies associated with the relay terminal device; means for comparing, at the PCF device, the first set of security policies with a second set of security policies associated with a relay service code (RSC); and means for based on determining that the first set of security policies match the second set of security policies, authorizing, at the PCF device, the RSC to the relay terminal device.

In a thirteenth aspect, there is provided a non-transitory computer-readable storage medium having instructions stored thereon. The instructions, when executed on at least one processor, cause the least one processor to perform the method of any of the fifth to eighth aspects.

In a fourteenth aspect, there is provided a computer program comprising instructions, which, when executed by an apparatus, cause the apparatus at least to: based on determining that path switching from a source relay terminal device having a first relay service code (RSC) associated with a first set of security policies is triggered, determine a second RSC; obtain a second set of security policies associated with the second RSC; and select a candidate relay terminal device having the second RSC as a target relay terminal device for the path switching in the event that the second set of security policies match the first set of security policies.

In a fifteenth aspect, there is provided a computer program comprising instructions, which, when executed by an apparatus, cause the apparatus at least to: based on receiving, from a remote terminal device associated with the control function device, a discovery key request comprising a second relay service code (RSC), obtain a second set of security policies associated with the second RSC, the set of second security policies comprising at least one second user plane (UP) security policy of a second packet data unit (PDU) session; and send, to the remote terminal device, a discovery key response comprising the second set of security policies associated with the second RSC.

In a sixteenth aspect, there is provided a computer program comprising instructions, which, when executed by an apparatus, cause the apparatus at least to: send, to a remote terminal device, a set of security policies associated with a plurality of relay service codes (RSCs), the plurality of RSCs comprise a first RSC associated with a source relay terminal device and a second RSC associated with a candidate relay terminal device, the set of security policies comprising at least one user plane (UP) security policy of a packet data unit (PDU) session.

In a seventeenth aspect, there is provided a computer program comprising instructions, which, when executed by an apparatus, cause the apparatus at least to: obtain, for a relay terminal device from a unified data management (UDM) device, a first set of security policies associated with the relay terminal device; compare the first set of security policies with a second set of security policies associated with a relay service code (RSC); and based on determining that the first set of security policies match the second set of security policies, authorize the RSC to the relay terminal device.

In an eighteenth aspect, there is provided a remote terminal device according to the first aspect. The remote terminal device comprises: determining circuitry configured to based on determining that path switching from a source relay terminal device having a first relay service code (RSC) associated with a first set of security policies is triggered, determine a second RSC; obtaining circuitry configured to obtain a second set of security policies associated with the second RSC; and selecting circuitry configured to select a candidate relay terminal device having the second RSC as a target relay terminal device for the path switching in the event that the second set of security policies match the first set of security policies.

In a nineteenth aspect, there is provided a control function device according to the second aspect. The control function device comprises: obtaining circuitry configured to based on receiving, from a remote terminal device associated with the control function device, a discovery key request comprising a second relay service code (RSC), obtain a second set of security policies associated with the second RSC, the set of second security policies comprising at least one second user plane (UP) security policy of a second packet data unit (PDU) session; and sending circuitry configured to send, to the remote terminal device, a discovery key response comprising the second set of security policies associated with the second RSC.

In a twentieth aspect, there is provided a policy control function (PCF) device according to the third aspect. The PCF device comprises: sending circuitry configured to send, to a remote terminal device, a set of security policies associated with a plurality of relay service codes (RSCs), the plurality of RSCs comprise a first RSC associated with a source relay terminal device and a second RSC associated with a candidate relay terminal device, the set of security policies comprising at least one user plane (UP) security policy of a packet data unit (PDU) session.

In a twenty-first aspect, there is provided a policy control function (PCF) device according to the fourth aspect. The PCF device comprises: obtaining circuitry configured to obtain, for a relay terminal device from a unified data management (UDM) device, a first set of security policies associated with the relay terminal device; comparing circuitry configured to compare the first set of security policies with a second set of security policies associated with a relay service code (RSC); and authorizing circuitry configured to based on determining that the first set of security policies match the second set of security policies, authorize the RSC to the relay terminal device.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1A illustrates an example of an application scenario in which some example embodiments of the present disclosure may be implemented;

FIG. 1B illustrates another example of an application scenario in which some example embodiments of the present disclosure may be implemented;

FIG. 2 illustrates an example signaling process for the path switching according to some example embodiments of the present disclosure;

FIG. 3 illustrates another example signaling process for the path switching according to some example embodiments of the present disclosure;

FIG. 4 illustrates still another example signaling process for the path switching according to some example embodiments of the present disclosure;

FIG. 5 illustrates yet another example signaling process for the path switching according to some example embodiments of the present disclosure;

FIG. 6 illustrates a flowchart of an example method implemented at a remote terminal device in accordance with some embodiments of the present disclosure;

FIG. 7 illustrates a flowchart of an example method implemented at a control function device in accordance with some embodiments of the present disclosure;

FIG. 8 illustrates a flowchart of an example method implemented at a PCF device in accordance with some embodiments of the present disclosure;

FIG. 9 illustrates another flowchart of an example method implemented at a PCF device in accordance with some embodiments of the present disclosure;

FIG. 10 illustrates a simplified block diagram of an apparatus that is suitable for implementing some example embodiments of the present disclosure; and

FIG. 11 illustrates a block diagram of an example of a computer-readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “network”, “communication network” or “data network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IoT), Wireless Fidelity (WiFi) and so on. Furthermore, the communications between a terminal device and a network device/element in the communication network may be performed according to any suitable generation communication protocols, including, but not limited to, the fourth generation (4G), 4.5G, the future fifth generation (5G), IEEE 802.11 communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a WiFi device, a relay, a low power node such as a femto, a pico, and so forth, depending on the applied terminology and technology. In the following description, the terms “network device”, “AP device”, “AP” and “access point” may be used interchangeably.

The term “terminal device”, “remote terminal device” or “relay terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), a station (STA) or station device, or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “station”, “station device”, “STA”, “terminal device”, “communication device”, “terminal”, “user equipment” and “UE” may be used interchangeably.

As mentioned above, in conventional IEEE 802.11 standards, SA2 working group has defined mechanism for ProSe remote terminal device to reselect a U2N relay terminal device from multiple candidate relay terminal devices. For example, 3GPP SA2 TR 23.700-33 has discussed support of path switching. Some exemplary parts are shown in the text box below.

Key issue#2 Support of path switching between two indirect network communication
paths for UE-to-Network Relaying with service continuity consideration
This key issue intends to support the path switching between two indirect network
communication paths for UE-to-Network Relaying with service continuity consideration.
This key issue should study whether all of the following path switching scenarios need to
be considered and how:

| | |
|---|---|
| - | Layer-3 UE-to-Network Relay with non-3GPP interworking function (N3IWF) |
| | switching from/to Layer-3 UE-to-Network Relay with N3IWF. |
| - | Layer-3 UE-to-Network Relay without N3IWF switching from/to Layer-3 |
| | UE-to-Network Relay without N3IWF. |
| - | Layer-3 UE-to-Network Relay without N3IWF switching from/to Layer-3 |
| | UE-to-Network Relay with N3IWF. |
| - | Layer-2 UE-to-Network Relay switching from/to Layer-2 UE-to-Network Relay. |
| - | Layer-2 UE-to-Network Relay switching from/to Layer-3 UE-to-Network Relay |
| | without N3IWF. |
| - | Layer-2 UE-to-Network Relay switching from/to Layer-3 UE-to-Network Relay with |
| | N3IWF. |

It is understood that service continuity in different path switching cases can be achieved
via application layer or session continuity. In this key issue, at least the following aspects
need to be considered:

| | |
|---|---|
| - | What are the triggers and criteria for path switching. |
| - | How to select a UE-to-Network Relay for path switching. |
| - | Identify the path switch procedure with service continuity consideration. |
| - | Identify how the service continuity is achieved for the solution in path switching. |

| | |
|---|---|
| NOTE: | Coordination with RAN WGs is needed for RAN dependency |

Conclusion Key Issue #2: Support of path switching between two indirect network
communication paths for UE-to-Network Relaying with service continuity
consideration
Support of path switching between two indirect network communication paths for
UE-to-Network Relaying with service continuity consideration, the followings are taken
as conclusions:

| - | For the triggers and criteria for path switching, the following principles are adopted | |
|---|---|---|
| | in normative work: | |
| | - | The Remote UE can path switch when the NG-RAN configured measurement |
| | | thresholds and the criteria are satisfied or based on re-selection rules from |
| | | application layer if any. |
| | - | If multiple UE-to-Network Relay UEs satisfy the Relay re-selection criteria, the |
| | | Remote UE selects the target UE-to-Network Relay for path switch based on the |
| | | 5G ProSe Policy in clause 6.5.4 of TS 23.304 or URSP rules and the Remote UE |
| | | traffic handling described in clause 6.5.4 of TS 23.304 with following |
| | | considerations: |

| | |
|---|---|
| - | The Remote UE first selects a Target relay UE which has same type as original |
| | relay UE, if this fails, then the Remote UE re-evaluates the URSP or keeps |
| | evaluating the next RSD of the selected URSP for Target Relay selection. |

| | |
|---|---|
| - | The Remote UE may use re-selection rules from the application layer (e.g. |
| | provided by an application server), the Remote UE may discover that there are |
| | multiple UE-to-Network Relay UEs that satisfy the re-selection rules and then |
| | selects the target UE-to-Network Relay UE based on priority in the re-selection |
| | rules from the application layer. |

| | NOTE 1: | The measurement trigger criteria for path switch between two indirect |
|---|---|---|
| | | network communication paths will be defined by RAN WGs. |
| | NOTE 2: | SA WG2 will not define the re-selection rules from application layer |
| | | and how they are provided to the UE. |
| - | To supporting path switch with service continuity, solution#15 is taken as baseline | |
| | for normative work. | |
| | NOTE 3: | The mechanisms supporting path switching by application layer for |
| | | service continuity are left to application layer implementation and |
| | | normative work is not needed. |
| | NOTE 4: | Handover procedures for path switch between Layer-2 UE-to-Network |

Relay indirect communication paths require coordination with RAN
WGs.

| | |
|---|---|
| - | For switching case between two indirect Layer-3 UE-to-Network Relay paths using |
| | N3IWF, solution#36 using MOBIKE is selected as basis for normative work. |

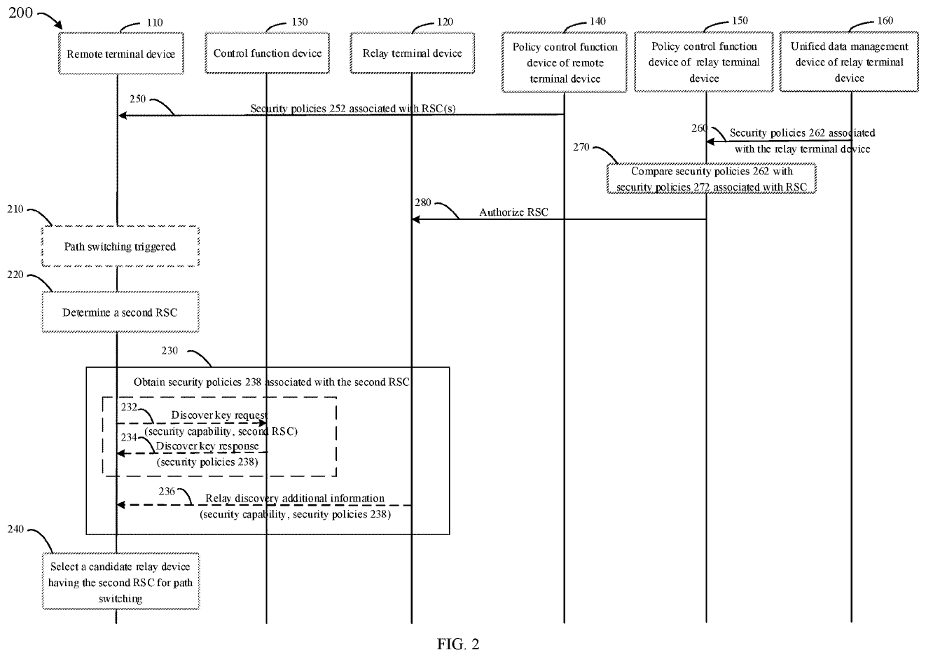

Solution #15: Service continuity support for path switch between two indirect
network communication paths
General Description
This solution addresses KI#2 (as defined in clause 5.2) to support service continuity for a
Remote UE connected to the network via a 5G ProSe UE-to-Network Relay (i.e. indirect
network communication path) switch to another indirect network communication path, as
shown in Figure 2.3.2-1.
As described in TS 23.304, Remote UE connect to the network via Layer-3
UE-to-Network Relay or Layer-3 UE-to-Network Relay with N3IWF access or Layer-2
UE-to-Network relay and can switch between any of these indirect network
communication paths.

| | |
|---|---|
| Editor's note: | Whether all the combinations of path switching (i.e. L2-L2, L2-L3, |

L3-L2, L3 with 2 variants) are needed is to be determined during
conclusion phase.

Procedures
Relay (re)selection
Target UE-to-Network Relay selection for path switch between indirect network
communication paths is performed by the UE or network as below:

| | |
|---|---|
| - | Layer-3 Remote UE and Layer-2 Remote UE in CM-IDLE or CM-CONNECTED |
| | with RRC_INACTIVE state select a target UE-to-Network Relay based on Remote |
| | UE controlled relay (re)selection procedures. |
| - | Layer-2 Remote UE in CM-CONNECTED with RRC_CONNECTED state is |
| | controlled by the network as part of the network controlled handover procedures as |
| | described in clause 6.15.2.2. |

Layer-3 Remote UE with/without N3IWF and Layer-2 Remote UE in CM-IDLE or
CM-CONNECTED with RRC_INACTIVE state keep performing the PC5 unicast link
measurements with its serving Relay to support Relay (re)selection, as specified in clause
6.5.3 of TS 23.304. When the NG-RAN configured measurement thresholds and the
criteria for indirect-to-indirect path relay (re)selection are satisfied, the Remote UE
performs the path switch to the target indirect network communication path. The target
UE-to-Network Relay can be either connected to the same NG-RAN or different
NG-RAN than the source UE-to-Network Relay.

| | |
|---|---|
| Editor's note: | The measurement trigger criteria for path switch between two |

indirect network communication paths will be defined by RAN WG.

If multiple UE-to-Network Relay UEs satisfy the Relay (re)selection criteria, the Layer-3
Remote UE select the target UE-to-Network Relay for path switch based on the 5G ProSe
Policy or URSP rules and the Remote UE traffic handling described in clause 6.5.4 of TS
23.304.
Service Continuity
The service continuity procedures that can be supported when Remote UE path switch
between indirect network communication paths differ based on whether both NAS and
AS connections are setup for Remote UE on the source indirect communication path to
the 5GS and whether both connections can be setup on the target indirect communication
path to the 5GS.

| - | Layer-3 Remote UE switch from Layer-3 UE-to-Network Relay to another Layer-3 | |
|---|---|---|
| | UE-to-Network Relay: Layer-3 Remote UE does not have any PDU session with | |
| | 5GC when connected via Layer-3 UE-to-Network Relay without N3IWF access. | |
| | Hence, application layer procedures are used for service continuity support. For | |
| | example: | |
| | - | Commercial IMS Services: IMS service continuity procedures specified in TS |
| | | 23.237. |
| | - | Missional Critical Services: service continuity procedures specified in Annex B of |
| | | TS 23.280, with the source path being an indirect communication path. |
| | - | Other services: application layer procedures specified outside of 3GPP scope can |
| | | be utilized if available. |
| - | Layer-3 Remote UE switch from Layer-3 UE-to-Network Relay with N3IWF support | |
| | to an indirect network communication path with either a Layer-3 UE-to-Network | |
| | Relay with N3IWF access or a Layer-2 UE-to-Network Relay: Layer-3 Remote UE | |
| | connected to N3IWF can handover the existing PDU session to the target path. | |
| | Hence, the handover procedures specified in clause 4.9.2 of TS 23.502 [8] for UE | |
| | mobility between a 3GPP access and Untrusted non-3GPP access, are considered as | |
| | baseline for session continuity support. | |
| - | Layer-2 Remote UE in CM-IDLE or CM-CONNECTED with RRC_INACTIVE | |
| | state performs path switch to an indirect network communication via Layer-2 | |
| | UE-to-Network Relay: Existing mobility procedure can be used, and session | |
| | continuity is supported with the existing procedures defined TS 23.502. | |
| - | Layer-2 Remote UE in CM-CONNECTED state path switch to an indirect | |
| | communication path via Layer-3 UE-to-Network Relay with N3IWF: Layer 2 | |
| | Remote UE's PDU session(s) can handover to the indirect path via Layer-3 | |
| | UE-to-Network Relay with N3IWF support. Thus, service continuity using the | |
| | handover procedures specified in clause 4.9.2 of TS 23.502 for UE mobility between | |
| | a 3GPP access and Untrusted non-3GPP access, are considered as baseline for | |
| | session continuity support. | |
| - | Layer-2 Remote UE in CM-CONNECTED state path switch to an indirect | |
| | communication path via Layer-2 UE-to-Network Relay: Network controlled | |
| | handover procedures defined for 3GPP access in clause 4.9.1 of TS 23.502 are reused | |
| | to support AS/NAS service continuity: | |
| | - | When Xn interface is supported between the source NG-RAN and target |
| | | NG-RAN, Xn based inter NG-RAN handover specified in clause 4.9.1.2 of TS |
| | | 23.502 are reused. |
| | - | When the Xn interface is not supported the source NG-RAN and target NG-RAN, |
| | | Inter NG-RAN node N2 based handover specified in clause 4.9.1.3 of TS 23.502 |
| | | are reused. |

| | |
|---|---|
| Editor's note: | Intra-NG-RAN and Inter-NG-RAN AS handover procedures for path |

switch between Layer-2 UE-to-Network Relay indirect communication
paths is defined by RAN WGs.

Still as mentioned above, in conventional IEEE 802.11 standards, SA3 working group has defined security for a discovery procedure to allow a remote terminal device to select a U2N relay terminal device based on the RSC and other parameters. For example, 3GPP SA3 TS 33.503 has discussed security for ProSe communication. Some exemplary parts are shown in the text box below.

Restricted 5G ProSe Direct Discovery Model A
Note: similar procedures are executed for Restricted 5G ProSe Direct Discovery Model B
The security procedure for restricted 5G ProSe Direct Discovery Model A is described as
follows.

| NOTE 1: | When the user-plane based security procedure for the UE-to-Network Relay is |
|---|---|
| | used, the 5G PKMF takes the role of the 5G DDNMF as described in 6.3.3.2 of |
| | the TS 33.503. |

Steps 1-4 refer to an Announcing UE:

| 1. | Announcing UE sends a Discovery Request message containing the Restricted |
|---|---|
| | ProSe Application User ID (RPAUID) to the 5G DDNMF in its HPLMN in order |
| | to get the ProSe Code to announce and to get the associated security material. In |
| | addition, the Announcing UE shall include its PC5 UE security capability that |
| | contains the list of supported ciphering algorithms by the UE in the Discovery |
| | Request message. |
| | For 5G ProSe UE-to-Network Relay discovery, the 5G ProSe UE-to-Network |
| | Relay plays the role as the Announcing UE and sends a Relay Discovery Key |
| | Request instead of a Discovery Request. The Relay Discovery Key Request |
| | message includes the Relay Service Code (RSC) and the 5G ProSe |
| | UE-to-Network Relay's PC5 security capability. |
| 2. | The 5G DDNMF may check for the announce authorization with the ProSe |
| | Application Server. |
| | For 5G ProSe UE-to-Network Relay discovery, this step is skipped. |
| 3. | If the Announcing UE is roaming, the 5G DDNMFs in the HPLMN and VPLMN |
| | of the Announcing UE exchange Announce Auth. |
| 4. | The 5G DDNMF in the HPLMN of the Announcing UE returns the ProSe |

Restricted Code and the corresponding Code-Sending Security Parameters, along
with the CURRENT_TIME and MAX_OFFSET parameters. The Code-Sending
Security Parameters provide the necessary information for the Announcing UE to
protect the transmission of the ProSe Restricted Code and are stored with the
ProSe Restricted Code. The Announcing UE takes the same actions with
CURRENT_TIME and MAX_OFFSET as described for the Announcing UE in
step 4 of clause 6.1.3.1 of the present document. The 5G DDNMF in the HPLMN
of the Announcing UE shall include the chosen PC5 ciphering algorithm in the
Discovery Response message. The 5G DDNMF determines the chosen PC5
ciphering algorithm based on the ProSe Restricted Code and the received PC5 UE
security capability in step 1. The UE stores the chosen PC5 ciphering algorithm
together with the ProSe Restricted Code.
In addition, the 5G DDNMF in the HPLMN of the Announcing UE may associate
the ProSe Restricted Code with the PC5 security policies and include the PC5
security policies in the Discovery Response message.
For 5G ProSe UE-to-Network Relay discovery, a Relay Discovery Key Response
is used instead of the Discovery Response, and the RSC is used instead of the
ProSe Restricted Code. The response message contains the discovery security
materials.

| NOTE 2: | 5G DDNMF may get the PC5 security policies in different ways (e.g. from |
|---|---|
| | PCF, from ProSe Application Server, or based on local configuration). |

Steps 5-10 refer to a Monitoring UE:

| 5. | The Monitoring UE sends a Discovery Request message containing the RPAUID |
|---|---|
| | and its PC5 UE security capability to the 5G DDNMF in its HPLMN in order to |
| | be allowed to monitor for one or more Restricted ProSe Application User IDs. |
| | For 5G ProSe UE-to-Network Relay discovery, the 5G ProSe Remote UE plays |
| | the role of the Monitoring UE and sends a Relay Discovery Key Request instead |
| | of the Discovery Request. The Relay Discovery Key Request message includes |
| | the RSC and the 5G ProSe Remote UE's PC5 security capability. |
| 6. | The 5G DDNMF in the HPLMN of the Monitoring UE sends an authorization |
| | request to the ProSe Application Server. If, based on the permission settings, the |
| | RPAUID is allowed to discover at least one of the Target RPAUIDs contained in |
| | the Application Level Container, the ProSe Application Server returns an |
| | authorization response. |
| | For 5G ProSe UE-to-Network Relay discovery, this step is skipped. |
| 7. | If the Discovery Request is authorized, and the PLMN ID in the Target RPAUID |
| | indicates a different PLMN, the 5G DDNMF in the HPLMN of the Monitoring |
| | UE contacts the indicated PLMN's 5G DDNMF (i.e. the 5G DDNMF in the |
| | HPLMN of the Announcing UE) by sending a Monitor Request message |
| | including the PC5 UE security capability received in step 5. |
| | For 5G ProSe UE-to-Network Relay Discovery, Relay Discovery Key Request |
| | and RSC are used instead of Discovery Request and RPAUID. |
| 8. | The 5G DDNMF in the HPLMN of the Announcing UE may exchange |
| | authorization messages with the ProSe Application Server. |
| | For 5G ProSe UE-to-Network Relay discovery, this step is skipped. |

| | |
|---|---|
| 9. | If the PC5 UE security capability in step 5 includes the chosen PC5 ciphering |

algorithm, the 5G DDNMF in the HPLMN of the Announcing UE responds to the
5G DDNMF in the HPLMN of the Monitoring UE with a Monitor Response
message including the ProSe Restricted Code, the corresponding Code-Receiving
Security Parameters, an optional Discovery User Integrity Key (DUIK), and the
chosen PC5 ciphering algorithm (based on the information/keys stored in step 4).
The Code-Receiving Security Parameters provide the information needed by the
Monitoring UE to undo the protection applied by the Announcing UE. The DUIK
shall be included as a separate parameter if the Code-Receiving Security
Parameters indicate that the Monitoring UE use Match Reports for MIC checking.
The 5G DDNMF in the HPLMN of the Monitoring UE stores the ProSe
Restricted Code and the Discovery User Integrity Key (if it received one outside
of the Code-Receiving Security Parameters).
For 5G ProSe UE-to-Network Relay discovery, a Relay Discovery Key Response
is used instead of the Discovery Response, and the RSC is used instead of the
ProSe Restricted Code. The response message contains the discovery security
materials.
The 5G DDNMF in the HPLMN of the Announcing UE may send the PC5
security policies associated with the ProSe Restricted Code to the 5G DDNMF in
the HPLMN of the Monitoring UE.

| NOTE 3: | There are two possible configurations for integrity checking, namely, MIC |
|---|---|
| | checked by the 5G DDNMF of the Monitoring UE, and MIC checked at the |
| | Monitoring UE side. Which configuration to use is decided by the 5G DDNMF, |
| | which assigns the monitored ProSe Restricted Code and signals the Monitoring |
| | UE in the Code-Receiving Security Parameters. |
| NOTE 4: | The chosen PC5 ciphering algorithm is associated with the ProSe Restricted |
| | Code. |

| | |
|---|---|
| 10. | The 5G DDNMF in the HPLMN of the Monitoring UE returns the Discovery |

Filter and the Code-Receiving Security Parameters, along with the
CURRENT_TIME and MAX_OFFSET parameters and the chosen PC5 ciphering
algorithm. The Monitoring UE takes the same actions with CURRENT_TIME
and MAX_OFFSET as described for the Monitoring UE in step 9 of clause
6.1.3.1 of the present document. The UE stores the Discovery Filter,
Code-Receiving Security Parameters, and the chosen PC5 ciphering algorithm
together with the ProSe Restricted Code.
If the 5G DDNMF in the HPLMN of the Monitoring UE receives the PC5
security policies associated with the ProSe Restricted Code in step 9, the
Monitoring UE's 5G DDNMF forwards the PC5 security policies to the
Monitoring UE.

Steps 11 and 12 occur over PC5:

| 11. | The UE starts announcing, if the UTC-based counter provided by the system |
|---|---|
| | associated with the discovery slot is within the MAX_OFFSET of the |
| | Announcing UE's ProSe clock and if the Validity Timer has not expired. The UE |
| | forms the discovery message and protects it. The four least significant bits of |
| | UTC-based counter are transmitted along with the protected discovery message. |
| 12. | The Monitoring UE listens for a discovery message that satisfies its Discovery |

Filter if the UTC-based counter associated with that discovery slot is within the
MAX_OFFSET of the monitoring UE's ProSe clock. In order to find such a
matching message, it processes the message. If the Monitoring UE was not asked
to send Match Reports for MIC checking, it stops at this step from a security
perspective. Otherwise, it proceeds to step 13.

| NOTE 5: | The UE checking the integrity of the discovery message on its own does not |
|---|---|
| | prevent the UE from sending a Match Report due to requirements in TS 23.304 |
| | [2]. If such a Match Report is sent, then there is no security functionality |
| | involved. |

Steps 13-16 refer to a Monitoring UE that has encountered a match:

| 13. | If the UE has either not had the 5G DDNMF check the MIC for the discovered |
|---|---|
| | ProSe Restricted Code previously or the 5G DDNMF has checked a MIC for |
| | the ProSe Restricted Code and the associated Match Report refresh timer (see |
| | step 15 for details of this timer) has expired, or as required based on the |
| | procedure specified in TS 23.304 [2], then the Monitoring UE sends a Match |
| | Report message to the 5G DDNMF in the HPLMN of the Monitoring UE. The |
| | Match Report contains the UTC-based counter value with four least significant |
| | bits equal to four least significant bits received along with discovery message |
| | and nearest to the Monitoring UE's UTC-based counter associated with the |
| | discovery slot where it heard the announcement, and other discovery message |
| | parameters including the ProSe Restricted Code and MIC. The 5G DDNMF |
| | checks the MIC. |
| 14. | The 5G DDNMF in the HPLMN of the Monitoring UE may exchange an Auth |
| | Req/Auth Resp with the ProSe Application Server to ensure that Monitoring UE |
| | is authorized to discover the Announcing UE. |
| | For 5G ProSe UE-to-Network Relay discovery, this step is skipped. |
| 15. | The 5G DDNMF in the HPLMN of the Monitoring UE returns to the |
| | Monitoring UE an acknowledgement that the integrity check passed. It also |
| | provides the CURRENT_TIME parameter, by which the UE (re)sets its ProSe |
| | clock. The 5G DDNMF in the HPLMN of the Monitoring UE included the |
| | Match Report refresh timer in the message to the Monitoring UE. The Match |
| | Report refresh timer indicates how long the UE will wait before sending a new |
| | Match Report for the ProSe Restricted Code. |
| 16. | The 5G DDNMF in the HPLMN of the Monitoring UE may send a Match |
| | Report Info message to the 5G DDNMF in the HPLMN of the Announcing UE. |

Security requirement for 5G ProSe UE-to-Network Relay Communication
The following security requirements apply to both 5G ProSe Layer-3 UE-to-Network
Relay and 5G ProSe Layer-2 UE-to-Network Relay:

| - | The 5G System shall support the authorization of the UE as a 5G ProSe |
|---|---|
| | UE-to-Network Relay in the 5G ProSe UE-to-Network Relay scenario. |
| - | The 5G System shall support the authorization of the UE as a 5G ProSe Remote UE |
| | in the 5G ProSe UE-to-Network Relay scenario. |
| - | For UE-to-Network Relay discovery, the security requirements in clause 6.1.2 apply. |
| - | The 5G System shall support a secure means to establish a PC5 link between the 5G |
| | ProSe Remote UE and the 5G ProSe UE-to-Network Relay. |
| - | The 5G System shall support confidentiality protection, integrity protection and |
| | replay protection for secure communication between the 5G ProSe Remote UE and |
| | the network via 5G ProSe UE-to-Network Relays. |
| - | PC5 signalling integrity security policy is set to “REQUIRED” for the 5G ProSe |
| | Remote UE and the 5G ProSe UE-to-Network Relay. |
| - | The 5G ProSe Remote UE shall establish a different PC5 security context with each |
| | different 5G ProSe UE-to-Network Relay and for each different Relay Service Code. |
| | It shall also be possible to establish a PC5 security context when the 5G ProSe |
| | Remote UE is out of coverage. |

Security for unicast mode 5G ProSe Direct Communication
General
The unicast mode 5G ProSe Direct Communication procedures are described in TS
23.304 [2]. Unicast mode 5G ProSe Direct Communication is used by two UEs that
directly exchange traffic for the ProSe applications running between the peer UEs.
PC5 security policy provisioning by 5G DDNMF for unicast mode 5G Prose Direct
Communication during the restricted 5G ProSe Discovery procedure is specified in clause
6.1.3.2.
PC5 direct communication security for relay services is specified in clause 6.3.
If the UE receives PC5 security policies from 5G DDNMF as specified in clause
6.1.3.2.2, the UE uses the PC5 security policies from 5G DDNMF to establish PC5
unicast communication security instead of the PC5 security policies provisioned by PCF
or pre-configured in UE as defined in TS 23.304 [2].
Security requirements
The initiating UE shall establish a different security context for each peer UE during the
PC5 unicast establishment if the security is activated. It shall be possible to establish
security context also when either one or both the 5G ProSe-enabled UEs are out of
coverage.
The mutual authentication between two 5G ProSe-enabled UEs during PC5 unicast shall
be supported.
The PC5 unicast signalling shall support confidentiality protection, integrity protection
and anti-replay protection.
The PC5 unicast user plane shall support confidentiality protection, integrity protection
and anti-replay protection.
The PCF shall be able to provision the PC5 security policies to the UE per ProSe
application during service authorization and information provisioning procedure as
defined in TS 23.304 [2].
The system shall support means for a secure refresh of the UE security context.

| NOTE: | The security context refresh may be triggered based on various options (e.g. |
|---|---|
| | validity time etc.). |

For example, 3GPP SA3 TS 33.536 has discussed security policy. Some exemplary parts are shown in the text box below.

5.3.3.1.4.2 Security policy
General
The PC5 unicast link shall support activation or deactivation of security based on the
security policy similar to Uu, as defined in TS 33.501[6]. The security policy shall be
provisioned for PC5 unicast link as well, as detailed in clause 5.3.3.1.4.2.2 of the present
document and handled as detailed in clause 5.3.3.1.4.2.3 of the present document.
Procedure for security policy provisioning for PC5 unicast link
For selectively activating or deactivation the security of the PC5 unicast link, the PCF
may provision the security policy per V2X service, during service authorization and
information provisioning procedure as defined in TS 23.287.
Security policy handling
For a NR PC5 unicast link, the UE shall be provisioned with the following:

| | |
|---|---|
| - | The list of V2X services, e.g. PSIDs or ITS-AIDs of the V2X applications, with |
| | Geographical Area(s) and their security policy which indicates the following: |
| - | Signalling integrity protection: REQUIRED/PREFERRED/NOT NEEDED |
| - | Signalling confidentiality protection: REQUIRED/PREFERRED/NOT NEEDED |
| - | User plane integrity protection: REQUIRED/PREFERRED/NOT NEEDED |
| - | User plane confidentiality protection: REQUIRED/PREFERRED/NOT NEEDED |

SA2 working group has defined UE subscription data types and additional parameters announcement procedure. Some exemplary parts are shown in the text box below.

3GPP SA2 TS 23.502 5.2.3.3.1 UE Subscription data types

| Subscription data type | Field | Description |
|---|---|---|
| Session Management | GPSI List | List of the GPSI (Generic Public Subscription |
| Subscription data | | Identifier) used both inside and outside of the |
| (data needed for | | 3GPP system to address a 3GPP subscription. |
| PDU Session | Internal Group ID-list | List of the subscribed internal group(s) that |
| Establishment) | | the UE belongs to. |
| | Trace Requirements | Trace requirements about a UE (e.g. trace |
| | | reference, address of the Trace Collection |
| | | Entity, etc . . .) is defined in TS 32.421 [39]. |
| | | This information is only sent to a SMF in the |
| | | HPLMN or one of its equivalent PLMN(s). |
| | Routing Indicator | Routing Indicator assigned to the SUPI. |
| | Session Management Subscription data contains one or more S-NSSAI level | |
| | subscription data: | |
| | S-NSSAI | Indicates the value of the S-NSSAI. |
| | Subscribed DNN list | List of the subscribed DNNs for the S-NSSAI |
| | | (NOTE 1). |
| | For each DNN in S-NSSAI level subscription data: | |
| | DNN | DNN for the PDU Session. |
| | Aerial service indication | Indicates whether the DNN is used for aerial |
| | | services (e.g. UAS operations or C2, etc.) as |
| | | described in TS 23.256 [80]. |
| | Framed Route information | Set of Framed Routes. A Framed Route refers |
| | | to a range of IPv4 addresses/IPv6 Prefixes to |
| | | associate with a PDU Session established on |
| | | this (DNN, S-NSSAI). |
| | | See NOTE 4. |
| | IP Index information | Information used for selecting how the UE IP |
| | | address is to be allocated (see clause 5.8.2.2.1 |
| | | in TS 23.501 [2]). |
| | Allowed PDU Session Types | Indicates the allowed PDU Session Types |
| | | (IPv4, IPv6, IPv4v6, Ethernet and |
| | | Unstructured) for the DNN, S-NSSAI. See |
| | | NOTE 6. |
| | Default PDU Session Type | Indicates the default PDU Session Type for |
| | | the DNN, S-NSSAI. |
| | Allowed SSC modes | Indicates the allowed SSC modes for the |
| | | DNN, S-NSSAI. |
| | Default SSC mode | Indicate the default SSC mode for the DNN, |
| | | S-NSSAI. |
| | Interworking with EPS | Indicates whether interworking with EPS is |
| | indication | supported for this DNN and S-NSSAI. |
| | 5GS Subscribed QoS profile | The QoS Flow level QoS parameter values |
| | | (5QI and ARP) for the DNN, S-NSSAI (see |
| | | clause 5.7.2.7 of TS 23.501 [2]). |
| | Charging Characteristics | It contains Charging Characteristics as defined |
| | | in Annex A clause A.1 of TS 32.255 [45]. |
| | | This information, when provided, shall |
| | | override any corresponding predefined |
| | | information at the SMF. |
| | Subscribed-Session-AMBR | The maximum aggregated uplink and |
| | | downlink MBRs to be shared across all |
| | | Non-GBR QoS Flows in each PDU Session, |
| | | which are established for the DNN, S-NSSAI. |
| | Static IP address/prefix | Indicate the static IP address/prefix for the |
| | | DNN, S-NSSAI. |
| | User Plane Security Policy | Indicates the security policy for integrity |
| | | protection and encryption for the user plane. |

3GPP SA2 TS 23.304 Additional parameters announcement procedure
Additional parameters announcement procedure outlined in Figure 2.4-1 is used by a 5G
ProSe Remote UE to request a 5G ProSe UE-to-Network Relay to announce additional
parameters (for model A) as defined in clause 5.8.3 of TS 23.304.

| | |
|---|---|
| 1. | 5G ProSe Remote UE has discovered a 5G ProSe UE-to-Network Relay and |
| | requires additional parameters. |
| 2. | The 5G ProSe Remote UE sends to the 5G ProSe UE-to-Network Relay an |
| | Additional Parameters Announcement Request to obtain additional parameters. |
| 3. | The 5G ProSe UE-to-Network Relay acknowledges receipt of the request in step 2 |
| | with an Additional Parameters Announcement Response |
| | (Additional_Parameters_Announcement_Request_Refresh Timer). The |
| | Additional_Parameters_Announcement_Request_Refresh Timer (configurable in |
| | the 5G ProSe UE-to-Network Relay), is provided to the 5G ProSe Remote UE so |
| | that when this timer expires the 5G ProSe Remote UE repeats the Additional |
| | Parameters Announcement Request procedure if it still needs to obtain the |
| | additional parameters. If the 5G ProSe Remote UE does not initiate new |
| | Additional Parameters Announcement Request procedure when this |
| | Additional_Parameters_Announcement_Request_Refresh Timer expires and no |
| | other UE request additional parameters announcement before the |
| | Additional_Parameters_Announcement_Request_Refresh timer expires in the 5G |
| | ProSe UE-to-Network Relay, then the relay shall stop announcing the additional |
| | parameters. |
| 4. | The 5G ProSe UE-to-Network Relay announces the additional parameters by |
| | sending Relay Discovery Additional Information message as defined in |
| | clause 5.8.3. This is repeated periodically with a configurable frequency |
| | (normally higher than the one related to the |
| | Additional_Parameters_Announcement_Request_Refresh Timer) until there is no |
| | UE requesting to announce the additional parameters as determined by the |
| | Additional_Parameters_Announcement_Request_Refresh Timer running in the |
| | 5G ProSe UE-to-Network Relay. |
| NOTE: | Based on UE implementation, the 5G ProSe UE-to-Network Relay can send the |
| | Relay Discovery Additional Information message several times consecutively |
| | in step 4 if there are other 5G ProSe Remote UE(s) that have connected to the |
| | 5G ProSe UE-to-Network Relay but not yet requested any additional |
| | parameters. This ensures the other 5G ProSe Remote UE(s) obtain such |
| | additional parameters without invoking any new request(s). |
| 5. | The 5G ProSe UE-to-Network Relay detects new or updated additional |
| | parameters. |
| 6. | Detection of new or updated additional parameters in step 5 triggers the 5G ProSe |
| | UE-to-Network Relay to announce the additional parameters by sending a Relay |
| | Discovery Additional Information Message immediately and to repeat it |
| | periodically with a configurable frequency as in step 4 until there are no UEs |
| | requesting to announce the additional parameters, i.e. until the |
| | Additional_Parameters_Announcement_Request_Refresh Timer expires in the 5G |
| | ProSe UE-to-Network Relay. |

As described above, SA2 is studying how to select a ProSe U2N Relay for path switching and identify the path switch procedure with service continuity consideration. According to conclusion in SA2 study, the path switching could happen between three modes of ProSe U2N relays using different RSCs, as shown in the below table.

| | Service | |
|---|---|---|
| Path Switching case | continuity level | Basic Principles |
| Between L3 relay without | Application layer | Commercial IMS Services; |
| N3IWF and L3 relay with or | | Missional Critical Services |
| without N3IWF or L2 relay | | |
| Between L3 relay with | Session level | Handover procedures specified in |
| N3IWF and L2 relay or L3 | | clause 4.9.2 of TS 23.502 for UE |
| relay with N3IWF | | mobility between a 3GPP access |
| | | and Untrusted non-3GPP access |
| Between L2 relay and L2 | Session level | CM-IDLE or CM-CONNECTED |
| relay | | with RRC_INACTIVE state: |
| | | Existing mobility procedure |
| | | CM-CONNECTED state: |
| | | Xn or N2 handover procedure |

3GPP has defined solutions to protect traffic from ProSe remote UE to external network through 3GPP network and ProSe U2N relay. Hop by hop protection is applied on each segment of the hop and thus finally end-to-end security is realized. Various security solutions are used for different modes of U2N relays. For example, PC5 security is applied for L3 relay with or without N3IWF, PDU session security of relay UE is applied for L3 relay without N3IWF, PDU session security of remote UE is applied for L2 relay, and Internet protocol security (IPSEC) is applied for L3 relay with N3IWF. Additionally, diverse PC5 and/or PDU security policies are configured for different RSCs of same or different modes of U2N relays. For example, UP integrity protection policy of PDU/PC5 for one RSC could be “required”, while the policy of another RSC could be “preferred” or “not needed”.

However, relayed traffic may be tampered or leaked after the ProSe remote UE switches from the currently used U2N relay to another U2N Relay. As an example, when a remote UE switches from a L3 relay with encryption required to another L3 relay with encryption not-needed, the sensitive UP traffic may be disclosed on PC5 link unintentionally. As an another example, when a remote UE switches from a L2 relay with integrity required to a L3 relay without N3IWF with integrity not-needed, the UP data maybe tampered on either PC5 and/or Uu interface of the new relay. As still an another example, when a remote UE switches from a L3/L2 relay with integrity required to L2 relay with integrity not-needed, the UP data maybe tampered on Uu interfacing with the new relay. Therefore, how to identify and select a U2N relay with security policies consistent with the currently used U2N relay during path switching across different RSCs needs to be considered.

In this disclosure, a solution is introduced to ensure the remote UE to select a U2N relay whose security policies are consistent with those of the currently used U2N relay. In this solution, the remote UE determines a new candidate RSC when the path switching is trigged, obtains security policies associated with the new candidate RSC, and selects a candidate relay having the new candidate RSC as the target relay if the security policies of the new candidate RSC match those of the currently used RSC. By this means, the proposed solution can ensure the security policies to be used after path switching match the security policies used before path switching, thereby preventing the relayed traffic from being tampered or leaked after the remote UE switches from the currently used U2N relay to another U2N relay.

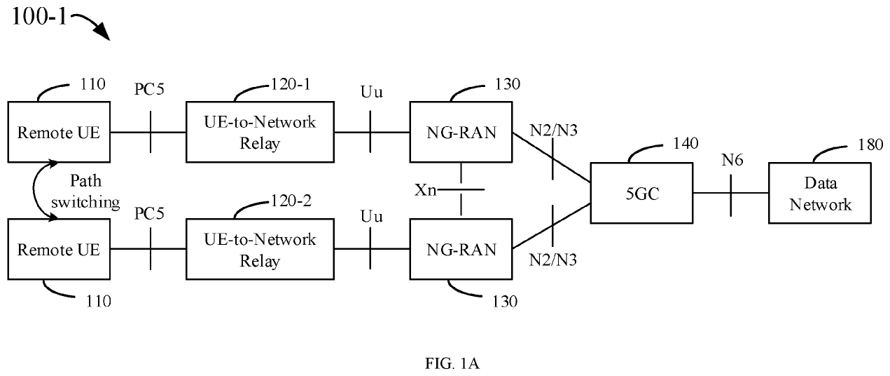

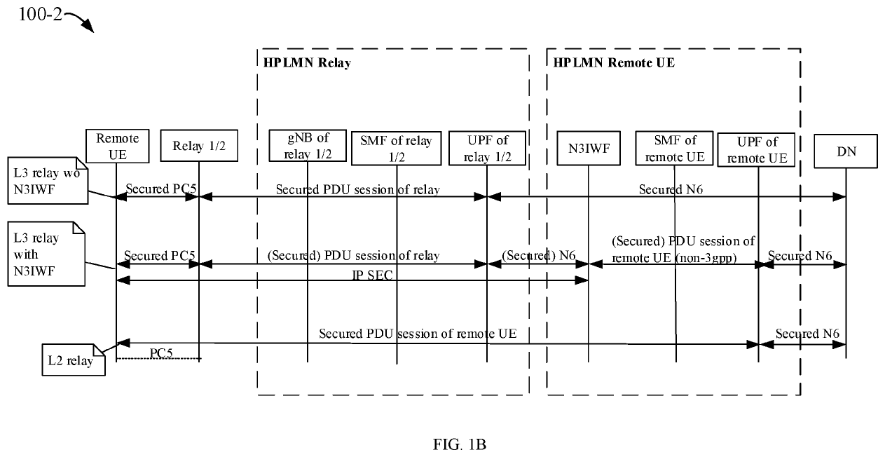

FIG. 1A illustrates an example of an application scenario 100-1 in which some example embodiments of the present disclosure may be implemented. The application scenario 100-1, which is a part of a communication network, includes a remote UE 110, a U2N relay 120-1, a U2N relay 120-2, new generation radio access network (NG-RAN) 130, 5GC 140 and a data network 180. Although only one remote UE 110 and two U2N relays 120 are shown in FIG. 1A, the numbers of the remote UE 110 and U2N relay 120 are not limited. In other words, there may be one or more remote UEs 110 and one or more U2N relays 120 in the network.

The remote UE 110 may connect to the U2N relay 120 via PC5 interface. The U2N relay 120 may connect to the NG-RAN 130 via Uu interface. The NG-RAN 130 may connect to the 5GC 140 via N2/N3 interface. The 5GC 140 may connect to data network 180 via N6 interface. In this way, the remote UE 110 may connect with the NG-RAN 130 via a U2N relay 120, which is called indirect network communication.

As shown in FIG. 1A, the remote UE 110 may establish a first indirect communication path with NG-RAN 130 via U2N relay 120-1 and a second indirect communication path with NG-RAN 130 via U2N relay 120-2. In some embodiments, the remote UE 110 may switch from the first indirect communication path to the second indirect communication path, which is called path switching. For example, when the remote UE 110 moves away from the U2N relay 120-1, it may need to switch to the U2N relay 120-2 for keeping continuous communication.

The communications in the application scenario 100-1 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM), Wireless Fidelity (WiFi) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, the sixth generation (6G), or IEEE 802.11 communication protocols.

It is to be understood that the number of devices and their connection relationships and types shown in FIG. 1A are for illustrative purposes only without suggesting any limitation. The application scenario 100-1 may comprise any suitable number of devices adapted for implementing embodiments of the present disclosure.

FIG. 1B illustrates another example of an application scenario in which some example embodiments of the present disclosure may be implemented. The application scenario 100-2, which is a part of a communication network, includes a remote UE, a relay 1/2, a gNB of relay 1/2, a Service Management Function (SMF) of relay 1/2, a user plane function (UPF) of relay 1/2, a N3IWF, a SMF of remote UE, a UPF of remote UE, a data network (DN).

As shown in FIG. 1B, different PC5 and PDU security policies are configured for different RSCs of same or different modes of U2N relays. For example, as for L3 relay without N3IMF, the PC5 link between the remote UE and the relay 1/2 is secured by PC5 security policies, and the PDU session between relay 1/2 and the UPF of relay 1/2 is secured by PDU session security policies of relay 1/2. For example, as for L3 relay with N3IMF, the PC5 link between the remote UE and the relay 1/2 may be secured by PC5 security policies, and the PDU session between the remote UE and the N3IWF for non-3gpp access for the remote UE is secured by IPSEC. For example, as for L2 relay, the PDU session between the remote UE and the UPF of remote UE is secured by PDU session security policies of remote UE.

It is to be understood that the number of devices and their connection relationships and types shown in FIG. 1B are for illustrative purposes only without suggesting any limitation. The application scenario 100-2 may comprise any suitable number of devices adapted for implementing embodiments of the present disclosure.

FIG. 2 illustrates an example signaling process 200 for the path switching according to some example embodiments of the present disclosure. For ease of understanding, the signaling process 200 will be described with reference to FIGS. 1A and 1B. The signaling process 200 may involve the remote terminal device 110 and the relay terminal device 120 (which correspond to the remote UE 110 and the U2N relay 120 in FIGS. 1A and 1B respectively). The signaling process 200 may also involve a control function device 130, a PCF device 140 of the remote terminal device 110, a PCF device 150 of the relay terminal device 120 and a UDM device 160 of the relay terminal device 120.

Signaling processes related to the remote terminal device 110 are described with reference to FIG. 2 as follows.

In some example embodiments, based on determining that path switching from a source relay terminal device having a first RSC associated with a first set of security policies is triggered (210), the remote terminal device 110 may determine (220) a second RSC. The first RSC may refer to the RSC currently used by the source relay terminal device in connection with the remote terminal device 110 before path switching. The second RSC may refer to a candidate RSC to be used after path switching. In some example embodiments, the remote terminal device 110 may select a second RSC from a plurality of candidate RSCs based on reselection rules defined by SA2 working group and security policies of the RSCs. In some example embodiments, the second RSC may be same as the first RSC. Alternatively, the second RSC may be different from the first RSC. In some example embodiments, different relay terminal devices may share a same RSC or have different RSCs. The relay terminal device has at least one corresponding RSC.

Additionally, after determining (220) a second RSC, the remote terminal device 110 may obtain (230) a second set of security policies 238 associated with the second RSC. Specifically, in some example embodiments, the remote terminal device 110 may send (232), to a control function device 130, a discovery key request comprising a first security capability of the remote terminal device 110 and the second RSC. Afterwards, the remote terminal device 110 may receive (234), from the control function device 130, a discovery key response comprising the second set of security policies 238. For example, the first security capability may contain a list of one or more crypto algorithms, each of the one or more crypto algorithms is same as or compatible with a crypto algorithm used to protect a PC5 path of the remote terminal device 110 with the source relay terminal device. In some example embodiments, the discovery key request may further comprise at least one of the first RSC and the first set of security policies associated with the first RSC.

Alternatively, in some example embodiments, the remote terminal device 110 may receive (236), from the relay terminal device 120, relay discovery additional information comprising the second set of security policies 238 and a second security capability of the relay terminal device 120. In some example embodiments, the second security capability may contain a list of one or more crypto algorithms to protect the PC5 path of the remote terminal device 110 with the relay terminal device 120.

After obtaining (230) the security policies 238, the remote terminal device 110 may select (240) the relay terminal device 120 having the second RSC as a target relay terminal device for the path switching in the event that the second set of security policies 238 match the first set of security policies. In some example embodiments, if the second set of security policies 238 are same as or compatible with the first set of security policies, the two set of security policies are matched.

Specifically, in some example embodiments, the remote terminal device 110 may determine whether the second set of security policies 238 match the first set of security policies. Further, in some example embodiments, if the remote terminal device 110 determines that the second set of security policies 238 match the first set of security policies, it may select the relay terminal device 120 as the target relay terminal device. Alternatively, in some other example embodiments, if the remote terminal device 110 determines that the second set of security policies 238 do not match the first set of security policies, it may try to select another relay terminal device having same or compatible security policies as the target relay terminal device.

Alternatively, in some example embodiments, the remote terminal device 110 may determine whether the second set of security policies 238 match the first set of security policies and whether the second security capability match a first security capability of the remote terminal device 110. Specifically, if the remote terminal device 110 determines that the second set of security policies 238 match the first set of security policies and the second security capability match the first security capability, it may select the relay terminal device 120 as the target relay terminal device. Alternatively, if the remote terminal device 110 determines that the second set of security policies 238 do not match the first set of security policies and/or the second security capability do not match the first security capability, it may try to select another candidate relay terminal device having same or compatible security policies and security capability as the target relay terminal device.

In some example embodiments, prior to the path switching triggered, the remote terminal device 110 may receive (250), from a PCF device 140 associated with the remote terminal device 110, security policies 252 associated with a plurality of RSCs which comprise the first RSC and the second RSC. In other words, the terminal device 110 may receive all security policies associated with all RSCs possibly used from the PCF device 140.

In some example embodiments, the first set of security policies comprises at least one first UP security policy of a first PDU session, and the second set of security policies 238 comprises at least one second UP security policy of a second PDU session. In some example embodiments, the first set of security policies may further comprise at least one first PC5 security policy, and the second set of security policies 238 may further comprise at least one second PC5 security policy.

Still referring to FIG. 2, signaling processes related to the control function device 130 are described as follows.

In some example embodiments, based on receiving (232), from the remote terminal device 120 associated with the control function device 130, a discovery key request comprising a second RSC, the control function device 130 may obtain a second set of security policies 238 associated with the second RSC, the set of second security policies comprising at least one second UP security policy of a second PDU session. Afterwards, the control function device 130 may send, to the remote terminal device 120, a discovery key response comprising the second set of security policies 238 associated with the second RSC.

In some example embodiments, the discovery key request may further comprise a first security capability of the remote terminal device 110. In some example embodiments, the discovery key request may further comprise at least one of a first RSC of a source relay terminal device and a first set of security policies associated with the first RSC.

In some example embodiments, the control function device 130 may send, to a control function device associated with a relay terminal device 120, a monitor key request comprising the first security capability and the second RSC. Afterwards, the control function device 130 may receive, from the control function device associated with the relay terminal device 120, a monitor key response comprising the second set of security policies 238.

In some example embodiments, the control function device 130 may determine whether the second set of security policies 238 match the first set of security policies, and may send the discovery key response including the second set of security policies 238 to the remote terminal device 110 based on determining that the second set of security policies 238 match the first set of security policies.

In some example embodiments, the control function device 130 may comprise at least one of a direct discovery name management function (DDNMF) device and a prose key management function (PKMF) device. The control function device associated with the relay terminal device 120 may comprise at least one of a DDNMF device and a PKMF device as well.

Still referring to FIG. 2, signaling processes related to the PCF device 140 are described as follows.

In some example embodiments, the PCF device 140 of the remote terminal device 110 may send (250), to the remote terminal device 140, a set of security policies associated with a plurality of RSCs. The plurality of RSCs may comprise a first RSC associated with a source relay terminal device and a second RSC associated with a candidate relay terminal device 120. The set of security policies may comprise at least one UP security policy of a PDU session. In some example embodiments, the set of security policies may further comprise at least one PC5 security policy.

Still referring to FIG. 2, signaling processes related to the PCF device 150 are described as follows.

In some example embodiments, the PCF device 150 of the relay terminal device 120 may obtain (260), for a relay terminal device 120 from a unified data management (UDM) device 160, a set of security policies 262 associated with the relay terminal device 120. Afterwards, the PCF device 150 may compare the set of security policies 262 with a set of security policies 272 associated with a RSC. The security policies 272 may be preconfigured in the PCF device 150 corresponding to a RSC. Afterwards, based on determining that the set of security policies 262 match the set of security policies 272, the PCF device 150 may authorize the RSC associated with the set of security policies 272 to the relay terminal device 120.

In some example embodiments, the set of security policies 262 may be obtained based on single network slice selection assistance information (S-NSSAI) and a data network name (DNN) associated with the RSC.

In some example embodiments, the set of security policies 262 or 272 comprises at least one UP security policy of a PDU session.

In the present disclosure, the security policies of the RSC are extended to cover both UP security of PC5 link(s) and PDU session(s). That means besides PC5 security policy (especially for U2N L3 relay), the UP security policies of potential PDU session (e.g., PDU session of the remote UE for U2N L2 relay, and PDU session of the relay UE for U2N L3 relay without N3IWF) associated to a RSC could also be stored in PCF and/or DDNMF.

In view of the above, it can be seen that the embodiments of the present disclosure could ensure the remote UE 110 to select a U2N relay 120 whose security policies are consistent with those of the currently used U2N relay. In other words, the embodiments of the present disclosure could ensure that the security policies to be used after path switching match the security policies before path switching, thereby preventing the relayed traffic from being tampered or leaked after the remote UE switches from the currently used U2N relay to a new U2N Relay.

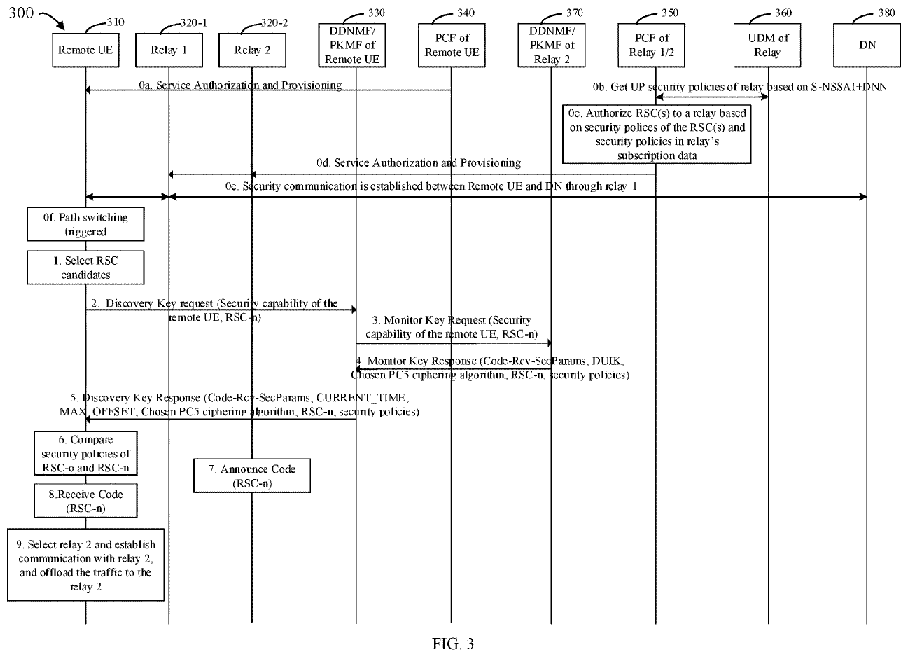

FIG. 3 illustrates another example signaling process 300 for the path switching according to some example embodiments of the present disclosure. It is noted that the signaling process 300 may be considered as an embodiment or an example of the signaling process 200 as shown in FIG. 2. For ease of understanding, the signaling process 300 will be described with reference to FIGS. 1A, 1B and 2. The signaling process 300 may involve the remote UE 310, relay 1 320-1, relay 2 320-2, DDNMF/PKMF 330 of remote UE, PCF 340 of remote UE, DDNMF/PKMF 370 of relay 2, PCF 350 of relay 1/2, UDM 360 of relay and data network (DN) 380. The “remote UE 310” is an example of “remote UE 110” and “remote terminal device 110” in FIGS. 1A and 2, “relay 1 320-1” or “relay 2 320-2” is an example of “U2N relay 120” and “relay terminal device 120” in FIGS. 1A and 2, “DDNMF/PKMF 330 of remote UE” is an example of “control function device 130” in FIG. 2, “PCF 340 of remote UE” is an example of “PCF device 140” in FIG. 2, “PCF 350 of relay 1/2” is an example of “PCF device 150” in FIG. 2, “UDM 360 of relay” is an example of “UDM device 160” in FIG. 2, and “DN 380” is an example of “data network 180” in FIG. 1.

As illustrated in FIG. 3, the signaling process before path switching may include steps 0a to 0e described as below.

At step 0a, together with other attributes, security policies of RSCs are provisioned from the PCF 340 of remote UE to the remote UE 310. The security policies may include security policies for the PC5 link and UP security policies of PDU sessions for relay 320.

At step 0b, before authorizing a RSC to a ProSe U2N relay 320, the PCF 350 of relay 1/2 may get UP security policies from subscription data of the relay UE 320 in a UDM of relay, based on a combination of S-NSSAI and DNN associated to the RSC.

At step 0c, the PCF 350 of relay UE compares the UP security policies received from the UDM 360 of relay with UP security policies preconfigured for the RSC in the PCF 350 of relay UE. If the UP security policies received from the UDM 360 and the UP security policies preconfigured are matched, the PCF 350 of relay UE may authorize the RSC to the relay 320 if other conditions are also satisfied.

At step 0d, together with other attributes, security policies of RSCs are provisioned from the PCF 350 of relay 1/2 to a U2N relay 1 320-1 or 2 320-2, which include security policies of PC5 link(s) and UP security policies of PDU session(s) for relay.

At step 0e, end-to-end security link may be built for the remote UE 310 to send traffic to DN via a relay 320 (e.g. relay 1). That means the remote UE has knowledge of a current RSC (RSC-o), security policies associated to the RSC-o, current relay (relay 1) and security algorithms used to protect the PC5 link.

Still referring to FIG. 3, the signaling process for path switching may include steps 0f to 9 described as below.

At step 0f, path switching is triggered.

At step 1, the remote UE 310 may select a new RSC based on reselection rules defined in SA2 (e.g., UE route selection policy (URSP), application rules, etc.) and security policies of the RSCs. The current RSC may be also selected. That is to say, the candidate relay may have a RSC same as the current RSC.

At step 2, the remote UE 310 may send a discovery key request to its DDNMF/PKMF 330 in HPLMN with one of selected RSCs from step 1. The discovery key request may include the security capability of the remote UE 310, the selected RSC (RSC-n, it may be same as RSC-o) and other parameters if need. Instead of sending all supported crypto algorithms, the remote UE 310 may only send the crypto algorithm(s) same as or compatible with that used to protect the current PC5 path.

At step 3, after receiving the discovery key request, the DDNMF/PKMF 330 in a HPLMN of remote UE (HPLMN-s) may authorize the selected RSC (RSC-n), then send a monitor key request to a DDNMF/PKMF 370 in a target HPLMN (HPLMN-t). The monitor key request may include a security capability of remote UE 310 and the selected RSC (RSC-n).

At step 4, the DDNMF/PKMF 330 in HPLMN-s may receive a successful monitor key response from the HPLMN-t, which may include security parameters, chosen algorithms for PC5 protection, security policies of RSC-n (comprising security policies of PC5 link(s) and/or UP security policies of PDU session(s) for relay), and other parameters.

At step 5, the DDNMF/PKMF 330 in HPLMN-s may forward the information in the monitor key response from the DDNMF/PKMF 370 in HPLMN-t to the remote UE through a discovery key response.

At step 6, after receiving the discovery key response, the remote UE 310 may compare the new security policies contained in the discovery key response with the old security policies. If the new security policies and the old security policies are matched, the remote UE 310 may store security parameters, security policies, algorithms for PC5 protection, associated to the RSC-n. Otherwise, the remote UE 310 may try to switch to a different U2N relay which has compatible security policies and capability with the current RSC (RSC-o).

At steps 7-8, the remote UE 310 may start discovering/monitoring the relay announcing the RSC-n over PC5 interface with the parameters stored in step 6.

At last, at step 9, the remote UE 310 may select a new U2N relay 320 (relay 2 320-2) associated with the RSC-n for communication, and offload the traffic to the relay 2 320-2.

In this embodiment, the remote UE 310 may verify whether the new security policies received from HPLMN 370 of the relay UE via HPLMN 330 of remote UE match the old security policies associated to the RSC-o.

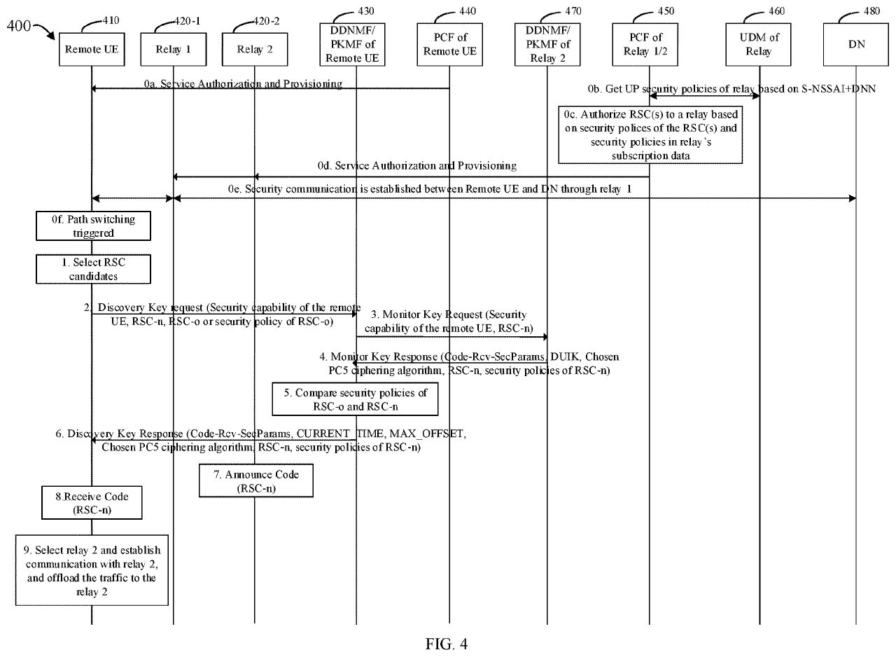

FIG. 4 illustrates still another example signaling process for the path switching according to some example embodiments of the present disclosure. It is noted that the signaling process 400 may be considered as an embodiment or an example of the signaling process 200 as shown in FIG. 2. For ease of understanding, the signaling process 400 will be described with reference to FIGS. 1A, 1B and 2. The signaling process 400 may involve the remote UE 410, relay 1 420-1, relay 2 420-2, DDNMF/PKMF 430 of remote UE, PCF 440 of remote UE, DDNMF/PKMF 470 of relay 2, PCF 450 of relay 1/2, UDM 460 of relay and data network (DN) 480. The “remote UE 410” is an example of “remote UE 110” and “remote terminal device 110” in FIGS. 1A and 2, “relay 1 420-1” or “relay 2 420-2” is an example of “U2N relay 120” and “relay terminal device 120” in FIGS. 1A and 2, “DDNMF/PKMF 430 of remote UE” is an example of “control function device 130” in FIG. 2, “PCF 440 of remote UE” is an example of “PCF device 140” in FIG. 2, “PCF 450 of relay 1/2” is an example of “PCF device 150” in FIG. 2, “UDM 460 of relay” is an example of “UDM device 160” in FIG. 2, and “DN 480” is an example of “data network 180” in FIG. 1.

As illustrated in FIG. 4, the signaling process before path switching may include steps 0a to 0e, which are same as steps 0a to 0e described with reference to FIG. 3 as above. The signaling process for path switching may also include steps 0f to 9, which are similar as those described with reference to FIG. 3 as above. Differences between the embodiment with reference to FIG. 4 and the embodiment with reference to FIG. 3 are described as below.

At step 2, additional parameters may be included in the discovery key request. The additional parameters may include the RSC (RSC-o) of the current path or security policies of the RSC-o used for the current path.

At step 5, after receiving a successful monitor key response from the DDNMF/PKMF 430 in HPLMN-t, which includes security parameters, chosen algorithms for PC5 protection, security policies of RSC-n (comprising security policies of PC5 link(s) and UP security policies of PDU session(s) for relay) and other parameters, the DDNMF/PKMF 430 in HPLMN-s may compare the new security policy contained in the monitor key response with the old security policies. If the new security policies and the old security policies are matched, the DDNMF/PKMF 430 in HPLMN-s may include the information from the DDNMF/PKMF 470 in HPLMN-t into the discovery key response sent to the remote UE 410. Then, the remote UE 410 may store security parameters, security policies, algorithms for PC5 protection, associated to the RSC-n, and start discovering/monitoring the relay announcing the RSC-n over PC5 interface with those parameters stored.

In this embodiment, the DDNMF/PKMF 430 in HPLMN of the remote UE verifies whether the security policies received from the DDNMF/PKMF 470 in HPLMN of the relay UE match the old security policies associated to the RSC-o.

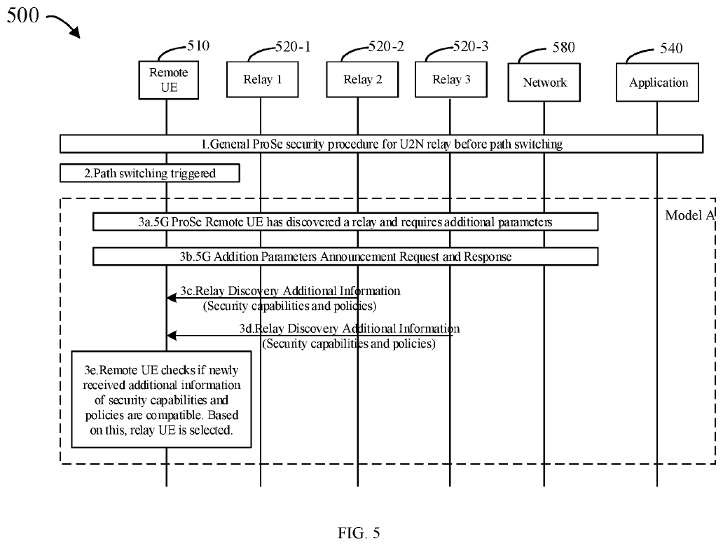

FIG. 5 illustrates yet another example signaling process 500 for the path switching according to some example embodiments of the present disclosure. It is noted that the signaling process 500 may be considered as an embodiment or an example of the signaling process 200 as shown in FIG. 2. For ease of understanding, the signaling process 500 will be described with reference to FIGS. 1A, 1B and 2. The signaling process 500 may involve the remote UE 510, relay 1 520-1, relay 2 520-2, relay 3 520-3, network 580 and application 540. The “remote UE 510” is an example of “remote UE 110” and “remote terminal device 110” in FIGS. 1A and 2, “relay 1 520-1”, “relay 2 520-2” or “relay 3 520-3” is an example of “U2N relay 120” and “relay terminal device 120” in FIGS. 1A and 2, and “network 580” is an example of “data network 180” in FIG. 1.

As illustrated in FIG. 5, the signaling process 500 may include steps 1 to 3e described as below.

At step 1, a general ProSe security procedure for U2N relay 520 before path switching is performed.

At step 2, path switching is triggered.

At step 3a, 5G ProSe remote UE 510 may discover a 5G ProSe U2N relay and requires additional parameters.

At step 3b, the 5G ProSe remote UE 510 may send to the 5G ProSe U2N relay 520 an additional parameters announcement request to obtain additional parameters. The 5G ProSe U2N relay 520 may acknowledge receipt of the additional parameters announcement request with an additional parameters announcement response.

At step 3c, the 5G ProSe U2N relay 2 520-2 may announce the additional parameters by sending a relay discovery additional information message. The relay discovery additional information message may comprise a set of second security policies 238 associated with relay 2 520-2 and a second security capability of the relay 2 520-2. Step 3d is similar as step 3c, which differs from step 3c in that the relay discovery additional information message is from relay 3. In some example embodiments, the second set of security policies 238 may comprise at least one second PC5 security policy and/or at least one first UP security policy of a first PDU session.

At step 3e, the remote UE 510 may check if the second set of security policies 238 are same as or compatible with those associated with the current RSC, and if the second security capability of the relay 2 520-2 is same as or compatible with that of the remote UE 510.

In this embodiment, the remote UE 510 could use additional parameters announcement request and response to fetch addition information such as the security capability and security policies in the discovery procedure. The remote UE 510 may verify whether the new security capability and security policies received from new relay UE 520 match the old security capability and security policies. Although FIG. 5 is described by taking the model A discovery procedure as example, the principle of FIG. 5 also applies for other discovery model types, such as a 5G ProSe direct discovery model B.

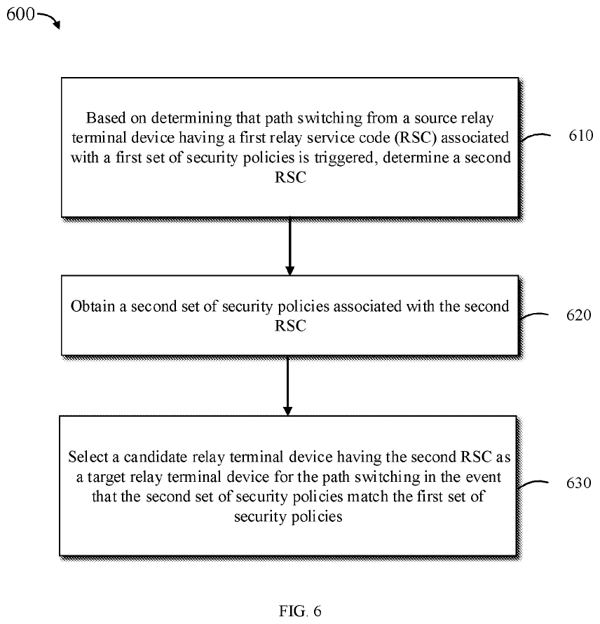

FIG. 6 illustrates a flowchart of an example method 600 implemented at a remote terminal device (for example, the remote terminal device 110) in accordance with some embodiments of the present disclosure. For ease of understanding, the method 600 will be described from the perspective of the remote terminal device 110 (i.e., remote UE) with reference to FIGS. 1-5.

At block 610, based on determining that path switching from a source relay terminal device having a first RSC (RSC-o) associated with a first set of security policies is triggered, the remote terminal device 110 may determine a second RSC. At block 620, the remote terminal device 110 may obtain a second set of security policies 238 associated with the second RSC. At block 630, the remote terminal device 110 may select a candidate relay terminal device 120 having the second RSC as a target relay terminal device for the path switching in the event that the second set of security policies 238 match the first set of security policies.

In some example embodiments, the remote terminal device 110 may determine whether the second set of security policies 238 match the first set of security policies. Then, the remote terminal device 110 may select the candidate relay terminal device 120 as the target relay terminal device based on determining that the second set of security policies 238 match the first set of security policies.

In some example embodiments, after determining the second RSC, the remote terminal device 110 may send, to a control function device 130 associated with the remote terminal device 110, a discovery key request comprising a first security capability of the remote terminal device 110 and the second RSC (RSC-n).

In some example embodiments, the first security capability contains a list of one or more crypto algorithms, each of the one or more crypto algorithms is same as or compatible with a crypto algorithm used to protect a PC5 path with the source relay terminal device.

In some example embodiments, the discovery key request further comprises at least one of the first RSC and the first set of security policies.

In some example embodiments, the remote terminal device 110 may receive, from a control function device 130 associated with the remote terminal device 110, a discovery key response comprising the second set of security policies 238.

In some example embodiments, prior to the path switching triggered, the remote terminal device 110 may receive, from a policy control function (PCF) device associated with the remote terminal device 110, security policies associated with a plurality of RSCs which comprise the first RSC and the second RSC.

Alternatively, in some other example embodiments, the remote terminal device 110 may receive, from the candidate relay terminal device 120, relay discovery additional information comprising the second set of security policies 238 and a second security capability of the candidate relay terminal device 120.

Alternatively, in some other example embodiments, the remote terminal device 110 may determine whether the second set of security policies 238 match the first set of security policies and whether the second security capability match a first security capability of the remote terminal device. Then, the remote terminal device 110 may select the candidate relay terminal device 120 as the target relay terminal device based on determining that the second set of security policies 238 match the first set of security policies and the second security capability match the first security capability.

In some example embodiments, the first set of security policies comprises at least one first UP security policy of a first PDU session, and the second set of security policies 238 comprises at least one second UP security policy of a second PDU session. In some example embodiments, the first set of security policies may further comprise at least one first PC5 security policy, and the second set of security policies 238 may further comprise at least one second PC5 security policy.

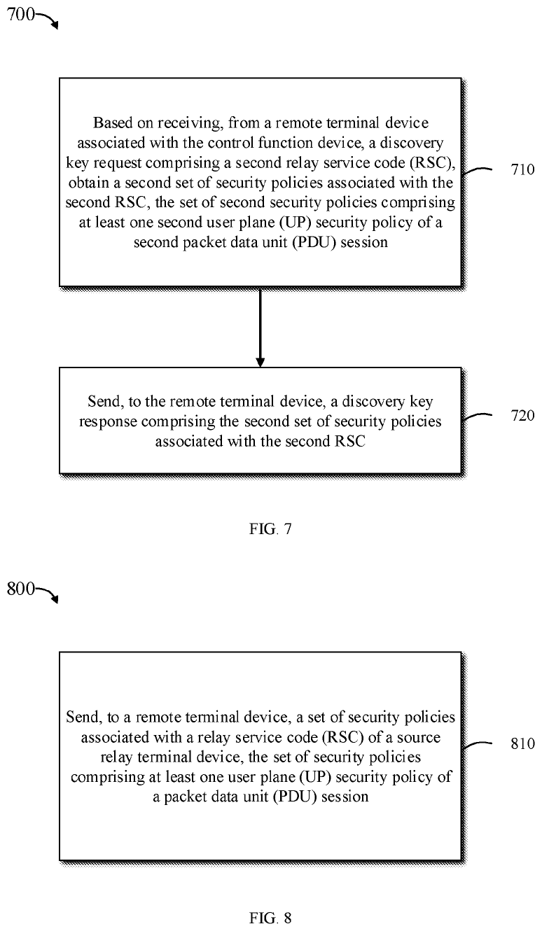

FIG. 7 illustrates a flowchart of an example method 700 implemented at a control function device (for example, a control function device 130) in accordance with some embodiments of the present disclosure. For ease of understanding, the method 700 will be described from the perspective of the control function device 130 (e.g., the DDNMF or PKMF) with reference to FIGS. 1-5.

At block 710, based on receiving, from a remote terminal device 110 associated with the control function device 130, a discovery key request comprising a second RSC, the control function device 130 may obtain a second set of security policies 238 associated with the second RSC, the set of second security policies 238 comprising at least one second UP security policy of a second PDU session. At block 720, the control function device 130 may send, to the remote terminal device 110, a discovery key response comprising the second set of security policies 238 associated with the second RSC.

In some example embodiments, the discovery key request may further comprise a first security capability of the remote terminal device 110.

In some example embodiments, the discovery key request may further comprise at least one of a first RSC of a source relay terminal device and a first set of security policies associated with the first RSC.

In some example embodiments, after receiving the discovery key request, the control function device 130 may send, to a control function device associated with a candidate relay terminal device 120, a monitor key request comprising the first security capability and the second RSC. Afterwards, the control function device 130 may receive, from the control function device associated with the candidate relay terminal device, a monitor key response comprising the second set of security policies 238.

In some example embodiments, the control function device 130 may determine whether the second set of security policies 238 match the first set of security policies. Afterwards, the control function device 130 may send the discovery key response based on determining that the second set of security policies 238 match the first set of security policies.

In some example embodiments, the second set of security policies 238 comprises at least one second UP security policy of a second PDU session. In some example embodiments, the first set of security policies comprises at least one first UP security policy of a first PDU session. In some example embodiments, the first set of security policies may further comprise at least one first PC5 security policy, and the second set of security policies 238 may further comprise at least one second PC5 security policy.

In some example embodiments, the control function device 130 may comprise at least one of a DDNMF device and a PKMF device.

FIG. 8 illustrates a flowchart of an example method 800 implemented at a PCF device (for example, a PCF device 140) in accordance with some embodiments of the present disclosure. For ease of understanding, the method 800 will be described from the perspective of the PCF device 140 with reference to FIGS. 1-5.

At block 810, the PCF device 140 may send, to a remote terminal device 110, a set of security policies 252 associated with a plurality of RSCs, the plurality of RSCs comprise a first RSC associated with a source relay terminal device and a second RSC associated with a candidate relay terminal device 120, the set of security policies 252 comprising at least one UP security policy of a PDU session.

In some example embodiments, the set of security policies 252 further comprise at least one PC5 security policy.

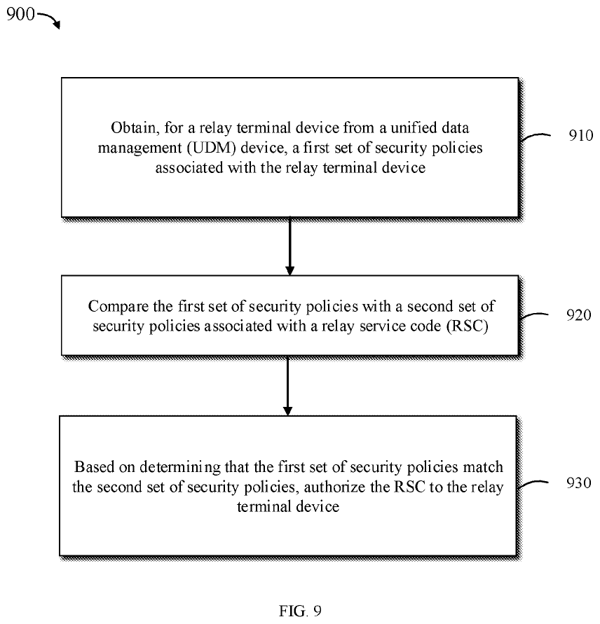

FIG. 9 illustrates another flowchart of an example method 900 implemented at a PCF device (for example, a PCF device 150) in accordance with some embodiments of the present disclosure. For ease of understanding, the method 900 will be described from the perspective of the PCF device 150 with reference to FIGS. 1-5.

At block 910, the PCF device 150 may obtain, for a relay terminal device 120 from a UDM device 160, a first set of security policies 262 associated with the relay terminal device 120. At block 920, the PCF device 150 may compare the first set of security policies 262 with a second set of security policies 272 associated with a RSC. At block 930, based on determining that the first set of security policies 262 match the second set of security policies 272, the PCF device 150 may authorize the RSC to the relay terminal device 120.

In some example embodiments, the first set of security policies 262 is obtained based on single network slice selection assistance information (S-NSSAI) and a data network name (DNN) associated with the RSC.

In some example embodiments, the first set of security policies 262 may comprise at least one first UP security policy of a first PDU session, and the second set of security policies 272 may comprise at least one second UP security policy of a second PDU session. In some example embodiments, the first set of security policies 262 may further comprise at least one first PC5 security policy, and the second set of security policies 272 may further comprise at least one second PC5 security policy.

In some example embodiments, an apparatus capable of performing the method 600 (for example, the remote terminal device 110) may comprise means for performing the respective steps of the method 600. The means may be implemented in any suitable form. For example, the means may be implemented in a circuitry or software module.

In some example embodiments, the apparatus comprises: means for based on determining that path switching from a source relay terminal device having a first RSC (RSC-o) associated with a first set of security policies is triggered, determine a second RSC; means for obtaining a second set of security policies 238 associated with the second RSC; and means for selecting a candidate relay terminal device 120 having the second RSC as a target relay terminal device for the path switching in the event that the second set of security policies 238 match the first set of security policies.

In some example embodiments, the means for selecting the candidate relay terminal device 120 comprises: means for determining whether the second set of security policies 238 match the first set of security policies; and means for select the candidate relay terminal device 120 as the target relay terminal device based on determining that the second set of security policies 238 match the first set of security policies.

In some example embodiments, the apparatus further comprises: means for after determining the second RSC, sending, to a control function device 130 associated with the remote terminal device 110, a discovery key request comprising a first security capability of the remote terminal device 110 and the second RSC (RSC-n).

In some example embodiments, the first security capability contains a list of one or more crypto algorithms, each of the one or more crypto algorithms is same as or compatible with a crypto algorithm used to protect a PC5 path with the source relay terminal device.

In some example embodiments, the discovery key request further comprises at least one of the first RSC and the first set of security policies.

In some example embodiments, the means for obtaining the second set of security policies comprises: means for receiving, from a control function device 130 associated with the remote terminal device 110, a discovery key response comprising the second set of security policies 238.

In some example embodiments, the apparatus further comprises: means for prior to the path switching triggered, receiving, from a policy control function (PCF) device associated with the remote terminal device 110, security policies associated with a plurality of RSCs which comprise the first RSC and the second RSC.

Alternatively, in some other example embodiments, the means for obtaining the second set of security policies comprises: means for receiving, from the candidate relay terminal device 120, relay discovery additional information comprising the second set of security policies 238 and a second security capability of the candidate relay terminal device 120.

Alternatively, in some other example embodiments, the means for selecting the candidate relay terminal device comprises: means for determining whether the second set of security policies 238 match the first set of security policies; means for determining whether the second security capability match a first security capability of the remote terminal device; and means for selecting the candidate relay terminal device 120 as the target relay terminal device based on determining that the second set of security policies 238 match the first set of security policies and the second security capability match the first security capability.

In some example embodiments, the first set of security policies comprises at least one first UP security policy of a first PDU session, and the second set of security policies comprises at least one second UP security policy of a second PDU session. In some example embodiments, the first set of security policies may further comprise at least one first PC5 security policy, and the second set of security policies may further comprise at least one second PC5 security policy.

In some example embodiments, the apparatus further comprises means for performing other steps in some embodiments of the method 600. In some embodiments, the means comprises at least one processor and at least one memory including computer program code, the at least one memory and computer program code configured to, with the at least one processor, cause the performance of the apparatus.

In some example embodiments, an apparatus capable of performing the method 700 (for example, the control function device 130) may comprise means for performing the respective steps of the method 700. The means may be implemented in any suitable form. For example, the means may be implemented in a circuitry or software module.

In some example embodiments, the apparatus comprises: means for based on receiving, from a remote terminal device 110 associated with the control function device 130, a discovery key request comprising a second RSC, obtaining a second set of security policies 238 associated with the second RSC, the set of second security policies 238 comprising at least one second UP security policy of a second PDU session; and means for sending, to the remote terminal device 110, a discovery key response comprising the second set of security policies 238 associated with the second RSC.

In some example embodiments, the discovery key request may further comprise a first security capability of the remote terminal device 110.

In some example embodiments, the discovery key request may further comprise at least one of a first RSC of a source relay terminal device and a first set of security policies associated with the first RSC.

In some example embodiments, the means for obtaining the second set of security policies comprises: means for after receiving the discovery key request, sending, to a control function device associated with a candidate relay terminal device 120, a monitor key request comprising the first security capability and the second RSC; and means for receiving, from the control function device associated with the candidate relay terminal device, a monitor key response comprising the second set of security policies 238.

In some example embodiments, the means for sending the discovery key response comprises: means for determining whether the second set of security policies 238 match the first set of security policies; and means for sending the discovery key response based on determining that the second set of security policies 238 match the first set of security policies.

In some example embodiments, the second set of security policies 238 comprises at least one second UP security policy of a second PDU session. In some example embodiments, the first set of security policies comprises at least one first UP security policy of a first PDU session. In some example embodiments, the first set of security policies may further comprise at least one first PC5 security policy, and the second set of security policies may further comprise at least one second PC5 security policy.

In some example embodiments, the apparatus comprises at least one of a DDNMF device and a PKMF device.

In some example embodiments, the apparatus further comprises means for performing other steps in some embodiments of the method 700. In some embodiments, the means comprises at least one processor and at least one memory including computer program code, the at least one memory and computer program code configured to, with the at least one processor, cause the performance of the apparatus.

In some example embodiments, an apparatus capable of performing the method 800 (for example, the PCF device 140) may comprise means for performing the respective steps of the method 800. The means may be implemented in any suitable form. For example, the means may be implemented in a circuitry or software module.

In some example embodiments, the apparatus comprises: means for sending, to a remote terminal device 110, a set of security policies 252 associated with a plurality of RSCs, the plurality of RSCs comprise a first RSC associated with a source relay terminal device and a second RSC associated with a candidate relay terminal device 120, the set of security policies 252 comprising at least one UP security policy of a PDU session.

In some example embodiments, the set of security policies 252 further comprise at least one PC5 security policy.

In some example embodiments, the apparatus further comprises means for performing other steps in some embodiments of the method 800. In some embodiments, the means comprises at least one processor and at least one memory including computer program code, the at least one memory and computer program code configured to, with the at least one processor, cause the performance of the apparatus.

In some example embodiments, an apparatus capable of performing the method 900 (for example, the PCF device 150) may comprise means for performing the respective steps of the method 900. The means may be implemented in any suitable form. For example, the means may be implemented in a circuitry or software module.

In some example embodiments, the apparatus comprises: means for obtaining, for a relay terminal device 120 from a UDM device 160, a first set of security policies 262 associated with the relay terminal device 120; means for comparing the first set of security policies 262 with a second set of security policies 272 associated with a RSC; and means for based on determining that the first set of security policies 262 match the second set of security policies 272, the PCF device 150 may authorize the RSC to the relay terminal device 120.

In some example embodiments, the first set of security policies 262 is obtained based on single network slice selection assistance information (S-NSSAI) and a data network name (DNN) associated with the RSC.

In some example embodiments, the first set of security policies 262 may comprise at least one first UP security policy of a first PDU session, and the second set of security policies 272 comprises at least one second UP security policy of a second PDU session. In some example embodiments, the first set of security policies 262 may further comprise at least one first PC5 security policy, and the second set of security policies 272 may further comprise at least one second PC5 security policy.

In some example embodiments, the apparatus further comprises means for performing other steps in some embodiments of the method 900. In some embodiments, the means comprises at least one processor and at least one memory including computer program code, the at least one memory and computer program code configured to, with the at least one processor, cause the performance of the apparatus.

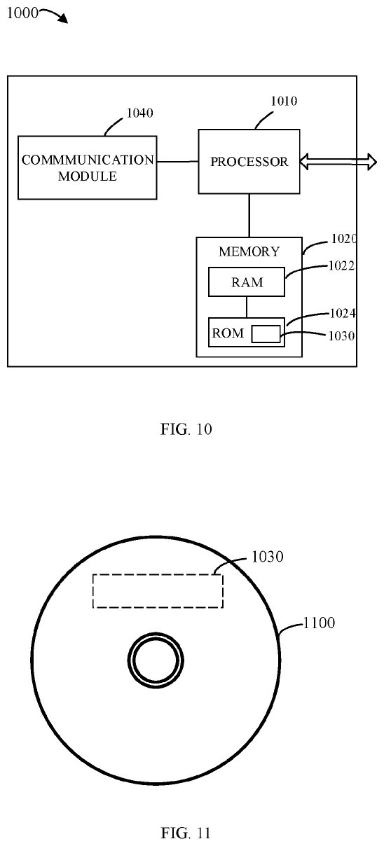

FIG. 10 illustrates a simplified block diagram of an apparatus 1000 that is suitable for implementing some example embodiments of the present disclosure. The apparatus 1000 may be provided to implement a communication device or a network element, for example, the remote terminal device 110, the relay terminal device 120, the control function device 130, the PCF device 140, the PCF device 150, the UDM device 160 as shown in FIG. 2. As shown, the apparatus 1000 includes one or more processors 1010, one or more memories 1020 coupled to the processor 1010, and one or more communication modules 1040 coupled to the processor 1010.

The communication module 1040 is for bidirectional communications. The communication module 1040 has at least one antenna to facilitate communication. The communication interface may represent any interface that is necessary for communication with other network elements.

The processor 1010 may be of any type suitable to the local technical network and may include one or more of the following: general purpose computers, special purpose computers, microprocessors, digital signal processors (DSPs) and processors based on multicore processor architecture, as non-limiting examples. The apparatus 1000 may have multiple processors, such as an application specific integrated circuit chip that is slaved in time to a clock which synchronizes the main processor.

The memory 1020 may include one or more non-volatile memories and one or more volatile memories. Examples of the non-volatile memories include, but are not limited to, a Read Only Memory (ROM) 1024, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1022 and other volatile memories that will not last in the power-down duration.

A computer program 1030 includes computer executable instructions that are executed by the associated processor 1010. The program 1030 may be stored in the ROM 1024. The processor 1010 may perform any suitable actions and processing by loading the program 1030 into the RAM 1022.

The embodiments of the present disclosure may be implemented by means of the program 1030 so that the apparatus 1000 may perform any process of the disclosure as discussed with reference to FIGS. 2 to 5. The embodiments of the present disclosure may also be implemented by hardware or by a combination of software and hardware.

In some example embodiments, the program 1030 may be tangibly contained in a computer-readable medium which may be included in the apparatus 1000 (such as in the memory 1020) or other storage devices that are accessible by the apparatus 1000. The apparatus 1000 may load the program 1030 from the computer-readable medium to the RAM 1022 for execution. The computer-readable medium may include any types of tangible non-volatile storage, such as ROM, EPROM, a flash memory, a hard disk, CD, DVD, and the like.

FIG. 11 illustrates a block diagram of an example of a computer-readable medium 1100 in accordance with some example embodiments of the present disclosure. The computer-readable medium 1100 has the program 1030 stored thereon. It is noted that although the computer-readable medium 1100 is depicted in form of CD or DVD in FIG. 10, the computer-readable medium 1100 may be in any other form suitable for carry or hold the program 1030.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer-readable storage medium. The computer program product includes computer-executable instructions, such as those included in program modules, being executed in a device on a target real or virtual processor, to carry out any one of the methods 600, 700, 800 and 900 as described above with reference to FIGS. 6-9. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer-readable medium, and the like.

The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

Through this document, the terms defined below may be referenced.
RSC relay service code
PCF policy control function
UP user plane
PDU packet data unit
DDNMF direct discovery name management function
PKMF prose key management function
UDM unified data management
S-NSSAI single network slice selection assistance information
DNN data network name
N3IWF non-3GPP interworking function

1-31. (canceled)

32. A remote terminal device comprising:
at least one processor; and
at least one memory storing instructions that, when executed by the at least one processor, cause the remote terminal device to:
based on determining that path switching from a source relay terminal device having a first relay service code (RSC) associated with a first set of security policies is triggered, determine a second RSC;
obtain a second set of security policies associated with the second RSC; and
select a candidate relay terminal device having the second RSC as a target relay terminal device for the path switching in the event that the second set of security policies match the first set of security policies.

33. The remote terminal device of claim 32, wherein the remote terminal device is caused to select the candidate relay terminal device by:
determining whether the second set of security policies match the first set of security policies; and
selecting the candidate relay terminal device as the target relay terminal device based on determining that the second set of security policies match the first set of security policies.

34. The remote terminal device of claim 32, wherein the remote terminal device is further caused to:
after determining the second RSC, send, to a control function device associated with the remote terminal device, a discovery key request comprising a first security capability of the remote terminal device and the second RSC.

35. The remote terminal device of claim 34, wherein the first security capability contains a list of one or more crypto algorithms, each of the one or more crypto algorithms is same as or compatible with a crypto algorithm used to protect a PC5 path with the source relay terminal device.

36. The remote terminal device of claim 34, wherein the discovery key request further comprises at least one of the first RSC and the first set of security policies.

37. The remote terminal device of claim 32, wherein the remote terminal device is caused to obtain the second set of security policies by:
receiving, from a control function device associated with the remote terminal device, a discovery key response comprising the second set of security policies.

38. The remote terminal device of claim 32, wherein the remote terminal device is further caused to:
prior to the path switching triggered, receive, from a policy control function (PCF) device associated with the remote terminal device, security policies associated with a plurality of RSCs which comprise the first RSC and the second RSC.

39. The remote terminal device of claim 32, wherein the remote terminal device is caused to obtain the second set of security policies by:
receiving, from the candidate relay terminal device, relay discovery additional information comprising the second set of security policies and a second security capability of the candidate relay terminal device.

40. The remote terminal device of claim 39, wherein the remote terminal device is caused to select the candidate relay terminal device by:
determining whether the second set of security policies match the first set of security policies;
determining whether the second security capability match a first security capability of the remote terminal device; and
selecting the candidate relay terminal device as the target relay terminal device based on determining that the second set of security policies match the first set of security policies and the second security capability match the first security capability.

41. The remote terminal device of claim 32, wherein
the first set of security policies comprises at least one first user plane (UP) security policy of a first packet data unit (PDU) session; and
the second set of security policies comprises at least one second user plane (UP) security policy of a second packet data unit (PDU) session.

42. A control function device comprising:
at least one processor; and
at least one memory storing instructions that, when executed by the at least one processor, cause the control function device to:
based on receiving, from a remote terminal device associated with the control function device, a discovery key request comprising a second relay service code (RSC), obtain a second set of security policies associated with the second RSC, the set of second security policies comprising at least one second user plane (UP) security policy of a second packet data unit (PDU) session; and
send, to the remote terminal device, a discovery key response comprising the second set of security policies associated with the second RSC.

43. The control function device of claim 42, wherein the discovery key request further comprises a first security capability of the remote terminal device.

44. The control function device of claim 42, wherein the discovery key request further comprises at least one of a first RSC of a source relay terminal device and a first set of security policies associated with the first RSC.

45. The control function device of claim 43, wherein the control function device is caused to obtain the second set of security policies by:
after receiving the discovery key request, send, to a control function device associated with a candidate relay terminal device, a monitor key request comprising the first security capability and the second RSC; and
receive, from the control function device associated with the candidate relay terminal device, a monitor key response comprising the second set of security policies.

46. The control function device of claim 44, wherein the control function device is caused to send the discovery key response by:
determining whether the second set of security policies match the first set of security policies; and
sending the discovery key response based on determining that the second set of security policies match the first set of security policies.

47. The control function device of claim 42, wherein the second set of security policies comprises at least one second user plane (UP) security policy of a second packet data unit (PDU) session.

48. The control function device of claim 42, wherein the control function device comprises at least one of a direct discovery name management function (DDNMF) device and a prose key management function (PKMF) device.

49. A policy control function (PCF) device comprising:
at least one processor; and
at least one memory storing instructions that, when executed by the at least one processor, cause the PCF device to:
send, to a remote terminal device, a set of security policies associated with a plurality of relay service codes (RSCs), the plurality of RSCs comprise a first RSC associated with a source relay terminal device and a second RSC associated with a candidate relay terminal device, the set of security policies comprising at least one user plane (UP) security policy of a packet data unit (PDU) session.

50. A policy control function (PCF) device comprising:
at least one processor; and
at least one memory storing instructions that, when executed by the at least one processor, cause the PCF device to:
obtain, for a relay terminal device from a unified data management (UDM) device, a first set of security policies associated with the relay terminal device;
compare the first set of security policies with a second set of security policies associated with a relay service code (RSC); and
based on determining that the first set of security policies match the second set of security policies, authorize the RSC to the relay terminal device.

51. The PCF device of claim 50, wherein the first set of security policies is obtained based on single network slice selection assistance information (S-NSSAI) and a data network name (DNN) associated with the RSC, and wherein the second set of security policies comprises at least one second user plane (UP) security policy of a second packet data unit (PDU) session.
